(19) United States
(12) Patent Application Publication
(10) Pub. No.: US 2024/0064530 A1
(43) Pub. Date: Feb. 22, 2024

(54) Application Layer Configuration of a Wireless Device

(71) Applicant: Telefonaktiebolaget LM Ericsson (publ), Stockholm (SE)

(72) Inventors: Ali Parichehrehteroujeni, Linköping (SE); Cecilia Eklöf, Täby (SE); Luca Lunardi, Genoa (IT); Johan Rune, Lidingö (SE); Filip Barac, Huddinge (SE)

(21) Appl. No.: 18/259,289

(22) PCT Filed: Jan. 3, 2022
(86) PCT No.: PCT/SE2022/050003

§ 371 Date: Jun. 26, 2023

Related U.S. Application Data
(60) Provisional application No. 63/134,100, filed on Jan. 5, 2021.

(51) Int. Cl. H04W 24/02; H04W 76/19

(52) U.S. Cl. CPC H04W 24/02; H04W 76/19; H04W 80/12

(57) ABSTRACT

A wireless device (12) configures an application layer (24) of the wireless device (12) with an application layer configuration (20-1) that governs performance of measurements at the application layer (24) and/or reporting of those measurements to a radio network layer (22) of the wireless device (12). After configuring the application layer (24) with the application layer configuration (20-1), the wireless device (12) receives at the radio network layer (22) a message (26) indicating a target configuration (16-2) with which the wireless device (12) is to be configured in association with a radio network layer procedure. Based on receiving the message (26), if each of one or more conditions are fulfilled, the wireless device (12) sends from the radio network layer (22) to the application layer (24) an instruction (30) on how the application layer (24) is to handle the application layer configuration (20-1).

### TECHNICAL FIELD

The present application relates generally to configuration of a wireless device, and relates more particularly to application layer configuration of such a wireless device.

### BACKGROUND

A wireless communication network controls the configuration of a wireless device in a number of respects, as part of configuring the wireless device to be served by the network. For example, when a wireless device performs a procedure at a radio network layer, such as a procedure for handover or for resuming or re-establishing a radio network layer connection, the wireless communication network sends the wireless device a new configuration, e.g., for use with a target node of the procedure. This new configuration includes configuration of the wireless device's radio network layer.

To better control the end-to-end quality experienced by a user of the wireless device, the wireless communication network may also configure quality of experience (QoE) measurements to be performed at the wireless device's application layer and reported to the network. Challenges arise, though, when the network configures the application layer in these or other ways in conjunction with configuring the device's radio network layer, e.g., as part of a procedure at the radio network layer. For example, if the network indicates to the wireless device's radio network layer that its configuration is to be entirely replaced with a new configuration, ambiguities exist about how to treat any existing configuration of the wireless device's application layer.

### SUMMARY

According to some embodiments herein, a wireless device's radio network layer instructs the wireless device's application layer on how to handle the application layer's configuration under some circumstances when the application layer's configuration is impacted by a radio network layer procedure. Such inter-layer communication or coordination between the radio network layer and the application layer thereby advantageously enables proper treatment of any existing application layer configuration, even when the impact to the existing application layer configuration is attributable to a radio network layer procedure. For example, when the target node of the radio network layer procedure does not fully support the existing application layer configuration, the radio network layer may instruct the application layer to delete or suspend at least a part of the application layer configuration, e.g., the part that governs performance of and/or reporting of measurements at the application layer, such as QoE measurements. The embodiments in this particular example, then, prevent the application layer from inefficiently performing and/or reporting application layer measurements when the target node of the radio network layer procedure does not support such application layer configuration.

More particularly, embodiments herein include a method performed by a wireless device. The method comprises configuring an application layer of the wireless device with an application layer configuration that governs performance of measurements at the application layer and/or reporting of those measurements to a radio network layer of the wireless device. The method also comprises, after configuring the application layer with the application layer configuration, receiving at the radio network layer a message indicating a target configuration with which the wireless device is to be configured in association with a radio network layer procedure, and based on receiving the message, if each of one or more conditions are fulfilled, sending from the radio network layer to the application layer an instruction on how the application layer is to handle the application layer configuration.

In some embodiments, the one or more conditions include a condition that the message indicates a full configuration option is applicable for the message. In this case, according to the full configuration option the wireless device is to be configured with the target configuration independent of any previous configuration of the wireless device.

In some embodiments, the radio network layer procedure is a procedure for handing over a radio network layer connection of the wireless device from a source network node to a target network node or a procedure for resuming or re-establishing at a target network node a radio network layer connection previously established at a source radio network node. In this case, the target configuration is a configuration with which the wireless device is to be configured for being served by the target network node.

In some embodiments, the one or more conditions include a condition that a target network node of the radio network layer procedure lacks full support of the application layer configuration.

In some embodiments, the one or more conditions include a condition that a target network node of the radio network layer procedure and a source network node of the radio network layer procedure are different network nodes.

In some embodiments, the method further comprises starting a timer upon reception of the message. In this case, the one or more conditions include a condition that the timer expires.

In one or more of these embodiments, the method further comprises, after successfully executing the radio network layer procedure to a first target network node, stopping the timer upon successfully executing another radio network layer procedure to a second target network node.

In some embodiments, the one or more conditions include a condition that the wireless device successfully connects to a target network node or cell of the radio network layer procedure.

In some embodiments, the one or more conditions include a condition that the wireless device disconnects from a source network node or cell of the radio network layer procedure.

In some embodiments, the instruction on how the application layer is to handle the application layer configuration is an instruction that the application layer is to delete or suspend at least a part of the application layer configuration. Additionally or alternatively, the instruction on how the application layer is to handle the application layer configuration is an instruction that the application layer is to reconfigure or replace at least a part of the application layer configuration. Additionally or alternatively, the instruction on how the application layer is to handle the application layer configuration is an instruction that the application layer is to stop or suspend performance of one or more actions governed by the application layer configuration. In one or more of these embodiments, the at least a part of the application layer configuration that is to be deleted, suspended, reconfigured, or replaced according to the instruction is a part that governs reporting of the measurements to the radio network layer and excludes a part that governs performance of the measurements at the application layer. Additionally or alternatively, the one or more actions whose performance is to be stopped or suspended according to the instruction includes reporting of the measurements to the radio network layer and excludes performance of the measurements at the application layer.

In some embodiments, the instruction on how the application layer is to handle the application layer configuration is an instruction that the application layer is to delete at least some measurement data collected in accordance with the application layer configuration.

In some embodiments, the instruction on how the application layer is to handle the application layer configuration is an instruction that the application layer is to suspend at least a part of the application layer configuration. In this case, the method further comprises starting a timer upon reception of the message, and if the timer expires, sending from the radio network layer to the application layer a further instruction that the application layer is to delete the at least part of the application layer configuration that was suspended. In this case, the method further comprises if, after successfully executing the radio network layer procedure to a first target network node, the wireless device successfully executes another radio network layer procedure to a second target network node before the timer expires, sending from the radio network layer to the application layer a further instruction that the application layer is to resume the at least part of the application layer configuration that was suspended.

In some embodiments, the instruction on how the application layer is to handle the application layer configuration is an instruction that the application layer is to suspend at least a part of the application layer configuration, that the application layer is to start a timer, and that the application layer is to delete the at least part of the application layer configuration that was suspended upon expiration of the timer. In this case, the method further comprises starting a corresponding timer at the radio network layer, and if, after successfully executing the radio network layer procedure to a first target network node, the wireless device successfully executes another radio network layer procedure to a second target network node before the corresponding timer expires, sending from the radio network layer to the application layer a further instruction that the application layer is to resume the at least part of the application layer configuration that was suspended.

In some embodiments, the application layer is configured with multiple concurrent application layer configurations. In this case, the instruction indicates to which of the multiple concurrent application layer configurations the instruction applies.

In some embodiments, the radio network layer is a radio resource control layer.

In some embodiments, the application layer configuration is a quality of experience, QoE, measurement that governs performance of QoE measurements at the application layer. Additionally or alternatively, the application layer configuration is a reporting configuration reporting of the QoE measurements to the radio network layer.

In some embodiments, the method further comprises receiving the instruction at the application layer, and handling the application layer configuration at the application layer in accordance with the received instruction.

In some embodiments, the method further comprises providing user data and forwarding the user data to a host computer via the transmission to a base station.

Other embodiments herein include a method performed by a radio network node serving a wireless device. The method comprises configuring an application layer of the wireless device with an application layer configuration that governs performance of measurements at the application layer. Additionally or alternatively, the method comprises configuring an application layer of the wireless device with an application layer configuration that governs reporting of those measurements to a radio network layer of the wireless device. The method further comprises, after the wireless device disconnects from the radio network node, at least temporarily preserving the application layer configuration at the radio network node.

In some embodiments, the method further comprises, after the wireless device has disconnected from the radio network node, if the wireless device re-connects to the radio network node while the application layer configuration is still preserved at the radio network node, resuming use of the application layer configuration for the wireless device.

In some embodiments, at least temporarily preserving the application layer configuration comprises starting a timer upon the wireless device disconnecting from the radio network node and preserving the application layer configuration until the timer expires. In one or more of these embodiments, the method further comprises stopping the timer upon the wireless device re-connecting to the radio network node.

In some embodiments, the radio network layer is a radio resource control layer.

In some embodiments, the application layer configuration is a quality of experience, QoE, measurement that governs performance of QoE measurements at the application layer. Additionally or alternatively, the application layer configuration is a reporting configuration that governs reporting of the QoE measurements to the radio network layer.

In some embodiments, the method further comprises obtaining user data and forwarding the user data to a host computer or a wireless device.

Other embodiments herein include a wireless device configured to perform any of the steps of the process described above for the wireless device.

Other embodiments herein include a wireless device comprises processing circuitry configured to perform any of the steps of the process described above for the wireless device.

Other embodiments herein include a wireless device comprises communication circuitry and processing circuitry. The processing circuitry is configured to perform any of the steps of the process described above for the wireless device.

Other embodiments herein include a wireless device comprising processing circuitry configured to perform any of the steps of the process described above for the wireless device. The wireless device also comprises power supply circuitry configured to supply power to the wireless device.

Other embodiments herein include a wireless device comprising processing circuitry and memory, the memory containing instructions executable by the processing circuitry whereby the wireless device is configured to perform any of the steps of the process described above for the wireless device.

Other embodiments herein include a user equipment (UE) comprising an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of the process described above for the wireless device. The UE also comprises an input interface connected to the processing circuitry and configured to allow input of information into the UE to be processed by the processing circuitry. The UE also comprises an output interface connected to the processing circuitry and configured to output information from the UE that has been processed by the processing circuitry. The UE also comprises a battery connected to the processing circuitry and configured to supply power to the UE.

Other embodiments herein include a computer program comprising instructions which, when executed by at least one processor of a wireless device, causes the wireless device to carry out the steps of the process described above for the wireless device.

In some embodiments, a carrier containing the computer program is one of an electronic signal, optical signal, radio signal, or computer readable storage medium.

Other embodiments herein include a radio network node configured to perform any of the steps of the process described above for the radio network node.

Other embodiments herein include a radio network node comprising processing circuitry configured to perform any of the steps of the process described above for the radio network node.

Other embodiments herein include a radio network node comprising communication circuitry and processing circuitry. The processing circuitry is configured to perform any of the steps of the process described above for the radio network node.

Other embodiments herein include a radio network node comprising processing circuitry configured to perform any of the steps of the process described above for the radio network node. The radio network node also comprises power supply circuitry configured to supply power to the radio network node.

Other embodiments herein include a radio network node comprising processing circuitry and memory, the memory containing instructions executable by the processing circuitry whereby the radio network node is configured to perform any of the steps of the process described above for the radio network node. In one or more of these embodiments, the radio network node is a base station.

Other embodiments herein include a computer program comprising instructions which, when executed by at least one processor of a radio network node, causes the radio network node to carry out the steps of the process described above for the radio network node. In one or more of these embodiments, the radio network node is a base station. In one or more of these embodiments, a carrier containing the computer program is one of an electronic signal, optical signal, radio signal, or computer readable storage medium.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication network according to some embodiments.

FIG. 2 is a block diagram of a 5G System architecture according to some embodiments.

FIG. 3 is a logic flow diagram of a method performed by a wireless device according to some embodiments.

FIG. 4 is a logic flow diagram of a method performed by a wireless device according to other embodiments.

FIG. 5 is a logic flow diagram of a method performed by a radio network node according to some embodiments.

FIG. 6 is a block diagram of a wireless device according to some embodiments.

FIG. 7 is a block diagram of a network node according to some embodiments.

FIG. 8 is a block diagram of a wireless communication network according to some embodiments.

FIG. 9 is a block diagram of a user equipment according to some embodiments.

FIG. 10 is a block diagram of a virtualization environment according to some embodiments.

FIG. 11 is a block diagram of a communication network with a host computer according to some embodiments.

FIG. 12 is a block diagram of a host computer according to some embodiments.

FIG. 13 is a flowchart illustrating a method implemented in a communication system, in accordance with one embodiment.

FIG. 14 is a flowchart illustrating a method implemented in a communication system, in accordance with one embodiment.

FIG. 15 is a flowchart illustrating a method implemented in a communication system, in accordance with one embodiment.

FIG. 16 is a flowchart illustrating a method implemented in a communication system, in accordance with one embodiment.

### DETAILED DESCRIPTION

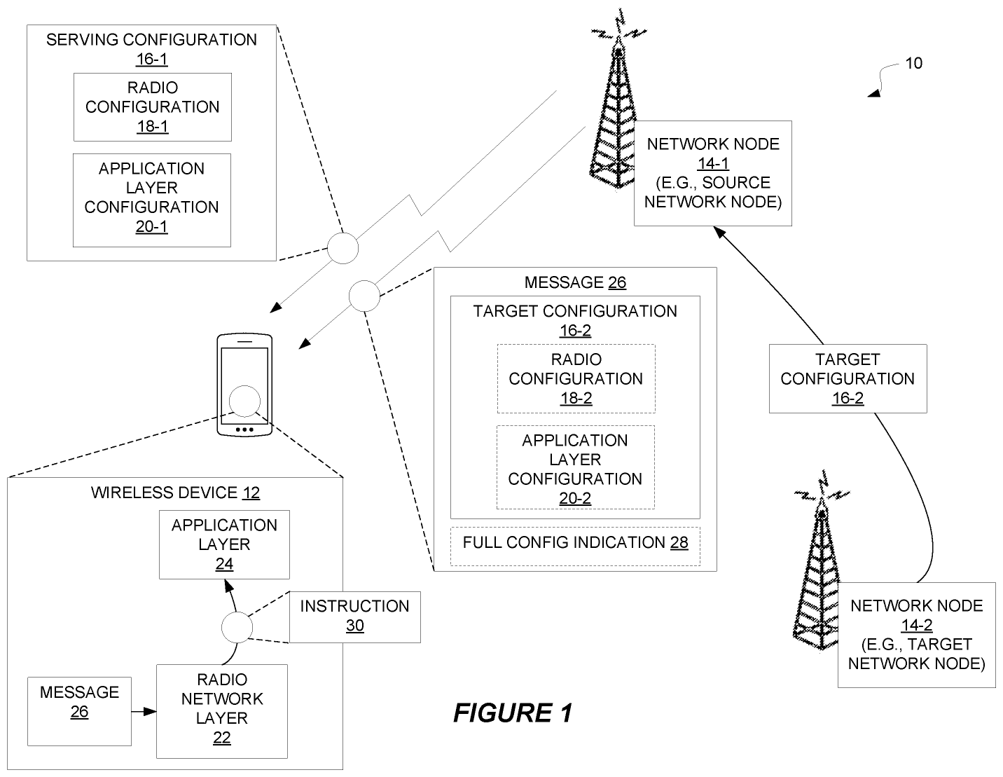

FIG. 1 shows a wireless communication network 10 according to some embodiments. The wireless communication network 10 serves a wireless device 12, e.g., in the form of a user equipment (UE). The wireless communication network 10 as shown in this regard includes a serving network node 14-1 (e.g., a radio network node) that serves the wireless device 12.

The wireless communication network 10 controls configuration of the wireless device 12 in a number of respects, as part of configuring the wireless device 12 to be served by the network 10. As shown, for example, the serving network node 14-1 may send the wireless device 12 a configuration 16-1, referred to for convenience as a serving configuration 16-1. The serving configuration 16-1 may include a radio configuration 18-1 according to which the wireless device 12 is to configure a radio network layer 22 (e.g., a radio resource control, RRC, layer) of the wireless device 12. The serving configuration 16-1 may alternatively or additionally include an application layer configuration 20-1 according to which the wireless device 12 is to configure an application layer 24 of the wireless device 12, e.g., wherein this application layer 24 is higher than the radio network layer 22 in a protocol stack of the wireless device 12.

In some embodiments, the application layer configuration 20-1 is a measurement and/or reporting configuration that governs performance of measurements at the application layer 24 and/or reporting of those measurements to the radio network layer 22, e.g., for relaying to the wireless communication network 10. Where the application layer configuration 20-1 is a measurement configuration, for instance, the application layer configuration 20-1 may govern when and/or how the measurements are to be performed at the application layer 24. Alternatively or additionally, where the application layer configuration 20-1 is a reporting configuration, the application layer configuration 20-1 may govern when and/or how the measurements performed at the application layer 24 are to be reported to the radio network layer 22, e.g., for relaying to the wireless communication network 10. Note here that, in some embodiments, reporting the measurements may comprise reporting the results of the measurements to the radio network layer 22.

As one example, the measurements at the application layer 24 may be quality of experience (QoE) measurements. The QoE measurements measure the end-to-end performance at the service level (i.e., the application layer) from the user's perspective. As an example in a video streaming context, the QoE measurements may measure video rebuffering, playback failures, and/or video startup time. In this example, then, the application layer configuration 20-1 may govern performance of QoE measurements at the application layer 24 and/or reporting of those QoE measurements to the radio network layer 22.

In any event, the wireless device 12 configures its application layer 24 with the application layer configuration 20-1, e.g., as received from the serving network node 14-1. This may involve for instance storing the application layer configuration 20-1, e.g., at the application layer 24 and/or setting one or more configuration parameters at the application layer 24 to have values specified by the application layer configuration 20-1. Where the application layer configuration 20-1 governs performance of measurements at the application layer 24 and/or reporting of those measurements to the radio network layer 22, the wireless device 12 may accordingly perform and/or report those application layer measurements in accordance with the application layer configuration 20-1.

At some point after configuring the application layer 24 with the application layer configuration 20-1, though, the wireless device 12 as shown receives a message 26 indicating a target configuration 16-2 with which the wireless device 12 is to be configured (or, in another sense, re-configured). The indicated target configuration 16-2 as shown for example includes a radio configuration 18-2 that may at least partially differ from the wireless device's existing radio configuration 18-1 and/or include an application layer configuration 20-2 that may at least partially differ from the wireless device's existing application layer configuration 20-2.

Regardless, in some embodiments, the wireless device 12 is to be configured with the target configuration 16-2 in association with a radio network layer procedure, e.g., an RRC procedure. The wireless device 12 in this case receives the message 26 at the radio network layer 22 as shown, as part of that radio network layer procedure. This may be the case even where the target configuration 16-2 indicated by the message 26 includes an application layer configuration 20-2. In one or more embodiments, for instance, the message 26 may be a transparent container that includes the application layer configuration 20-2.

Based on receiving the message 26, the wireless device 12 according to some embodiments sends from the radio network layer 22 to the application layer 24 an instruction 30 on how the application layer 24 is to handle the application layer configuration 20-1 (with which the application layer 24 is already configured). The instruction 30 may thereby address how the application layer 24 is to handle the application layer configuration 20-1 in view of the target configuration 16-2, such that the instruction 30 effectively accounts for the target configuration 16-2.

For example, in some embodiments, the instruction 30 instructs the application layer 24 to delete or suspend at least a part of the application layer configuration 20-1, reconfigure or replace at least a part of the application layer configuration 20-1, and/or stop or suspend performance of one or more actions governed by the application layer configuration 20-1. Where the application layer configuration 20-1 governs performance of and/or reporting of measurements at the application layer 24, for instance, the instruction 30 may effectively instruct the application layer 24 to stop or suspend performance of and/or reporting of those measurements. Alternatively or additionally, the instruction 30 may instruct the application layer 24 to delete at least some measurement data collected in accordance with the application layer configuration 20-1.

No matter the particular instruction given by the instruction 30, the application layer 24 correspondingly receives the instruction 30 and handles the application layer configuration 20-1 in accordance with that instruction 30. This may include, for example, deleting or suspending at least a part of the application layer configuration 20-1, reconfiguring or replacing at least a part of the application layer configuration 20-1, and/or stopping or suspending performance of one or more actions governed by the application layer configuration 20-1.

In some embodiments, the wireless device 12 is configured with the target configuration 16-2 in association with a radio network layer procedure for handing over a radio network layer connection of the wireless device 12 from the serving network node 14-1 (also referred to as a source network node) to a target network node 14-2. Or, a radio network layer procedure for resuming or re-establishing at the target network node 14-2 a radio network layer connection previously established at the serving network node 14-1. In any of these embodiments, the target configuration 16-2 may be a configuration with which the wireless device 12 is to be configured for being served by the target network node 14-2, i.e., after handing over to the target network node 14-2 or after resuming or re-establishing its radio network layer connection at the target network node 14-2. In fact, as shown in FIG. 1, the target network node 14-2 may the node that generates the target configuration 16-2 and sends the target configuration 16-2 to the wireless device 12 via the serving network node 14-1. In some embodiments, then, the instruction 30 instructs the application layer 24 on how to handle its existing (source) application layer configuration 20-1 to account for the new target configuration 16-2 provided by the target network node 14-2 of a handover, connection resume, or connection re-establishment procedure.

In these and other embodiments, the wireless device's sending of the instruction 30 may be conditioned on each of one or more conditions being fulfilled. In some embodiments, for example, the one or more conditions include a condition that the target network node 14-2 of the radio network layer procedure lacks full support of the (source) application layer configuration 20-1. Lack of full support may mean for instance that the target network node 14-2 does not support one or more components or configuration parameters specified by the application layer configuration 20-1. Accordingly, in this case, the instruction 30 (e.g., to delete or suspend the existing application layer configuration 20-1) may be sent selectively when the target network node 14-2 lacks full support of that application layer configuration 20-1.

In some embodiments, the message 26 implicitly or explicitly indicates that the target network node 14-2 lacks full support of the application layer configuration 20-1. The message 26 may for instance include a flag that explicitly indicates lack of full support for the existing application layer configuration 20-1. Or, in other embodiments, a full configuration option indication 28 effectively (e.g., implicitly) indicates lack of full support for the existing application layer configuration 20-1.

More particularly, in some embodiments, the message 26 is capable of being configured to directly and/or explicitly indicate the target configuration 16-2 in its entirety, e.g., by directly and/or explicitly indicating each value of each configuration parameter specified by the target configuration 16-2. In these and other embodiments, the message 26 may be said to specify the target configuration 16-2 fully, independent of any previous configuration of the wireless device 12, e.g., independent of the serving configuration 16-2. In one or more of these embodiments, then, the message 26 includes a full configuration (option) indication 28 that indicates whether or not a full configuration option is applicable for the message 26, where according to the full configuration option the wireless device 12 is to be configured with the target configuration 16-2 independent of any previous configuration of the wireless device 12.

In some embodiments, the target network node 14-2 sets the full configuration (option) indication 28 to indicate that the full configuration option is applicable for the message 26, e.g., when the target network node 14-2 lacks full support for the existing application layer configuration 20-1. Correspondingly, the one or more conditions for sending the instruction 30 may include a condition that the message 26 indicates a full configuration option is applicable for the message 26. In this case, then, the wireless device 12 sends the instruction 30 to the application layer 24 if the full configuration option is applicable for the message 26 (e.g., in which case the target network node 14-1 lacks full support for the application layer configuration 20-1) but refrains from sending the instruction 30) to the application layer 24 if the full configuration option is not applicable for the message 26 (e.g., in which case the target network node 14-1 fully supports the application layer configuration 20-1).

Alternatively or additionally, the one or more conditions for sending the instruction 30 may include a condition that the wireless device 12 successfully connects to the target network node 14-2 (or target cell) and/or that the wireless device 12 disconnects from the serving network node 14-1 (or serving cell).

Alternatively or additionally, the one or more conditions for sending the instruction 30 may include a condition that, after successfully executing the radio network layer procedure to the target network node 14-2, the wireless device 12 has not successfully executed another radio network layer procedure (e.g., another handover procedure) to another target network node within a certain duration. This effectively means the wireless device 12 delays or defers sending the instruction 30 until after a certain duration has passed since successfully executing the radio network layer procedure (e.g., handover procedure) to the target network node 14-2, e.g., in case the instruction 30 becomes unnecessary due to the wireless device 12 subsequently executing another radio network layer procedure to another target network node, which may be the original serving network node 14-1 or a new target network node. In some embodiments, the wireless device 12 implements these embodiments by starting a timer upon reception of the message 26, and conditioning sending of the instruction 30 on expiration of the timer. In this case, the wireless device 12 stops the timer upon successfully executing another radio network layer procedure to a second target network node, which, again, can be the original serving network node 14-1 or a new target network node (not shown). In these and other embodiments, the serving network node 14-1 may at least temporarily preserve the application layer configuration 20-1 at the serving network node 14-1, even after the wireless device 12 disconnects from the serving network node 14-1, e.g., in case the wireless device 12 returns back to the serving network node 14-1 within a certain duration.

One or more embodiments will now be exemplified in a context where the application layer measurements are QoE measurements and the wireless communication network 10 is configured according to 3GPP specifications, such as a Long Term Evolution (LTE) network or a 5G or Next Generation (NG) network. In this case, the wireless device 12 herein may be exemplified as a user equipment (UE) and/or a radio network node 14-1, 14-2 may be exemplified as an eNB or gNB. Moreover, in one or more embodiments exemplified below, the radio network layer 22 is exemplified as an RRC layer.

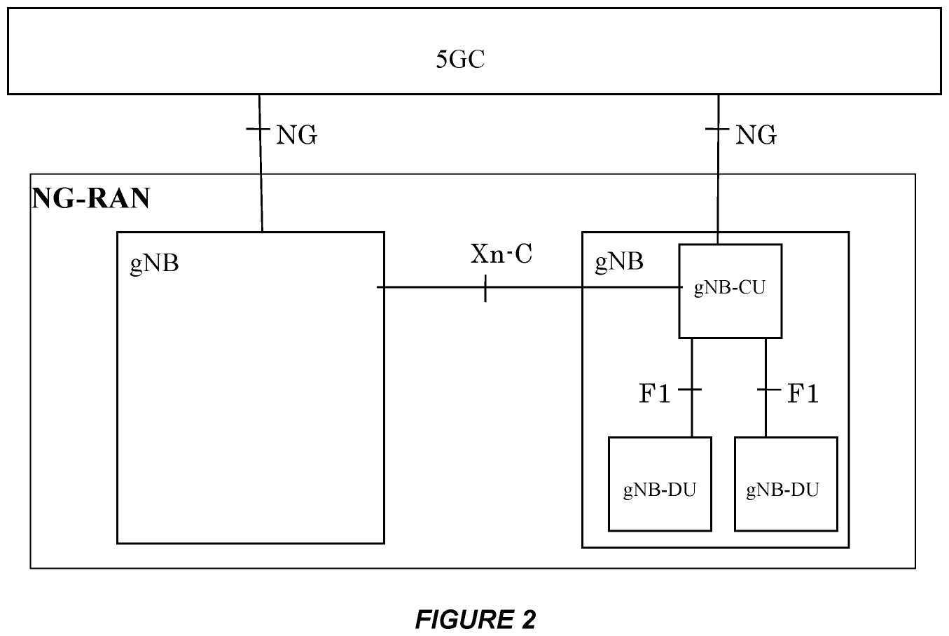

FIG. 2 shows the overall architecture of a 5G network within which embodiments herein may be exemplified. As shown, the NG-RAN consists of a set of gNBs connected to the 5G Core (5GC) through the NG interface. gNBs can be interconnected through the Xn interface.

A gNB may consist of a gNB central unit (gNB-CU) and one or more gNB distributed units (gNB-DU(s)). A gNB-CU and a gNB-DU are connected via the F1 interface. One gNB-DU is connected to only one gNB-CU. For resiliency, a gNB-DU may be connected to multiple gNB-CUs by appropriate implementation. NG, Xn, and F1 are logical interfaces.

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1), the related TNL protocol and the functionality are specified. The TNL provides services for user plane transport and signalling transport.

In these and other contexts, the purpose of application layer measurements, such as QoE measurements, is to measure the end user experience when using certain applications. QoE measurements may be supported, for example, for streaming services and for MTSI (Mobility Telephony Service for IMS).

Quality of Experience measurement collection enables configuration of application layer measurements in the UE and transmission of QoE measurement result files by means of RRC signalling. An application layer measurement configuration received from operations and maintenance (OAM) or the core network (CN) is encapsulated in a transparent container, which is forwarded to UE in a downlink RRC message. Application layer measurements received from UE's higher layer are encapsulated in a transparent container and sent to network in an uplink RRC message. The resulting container is then forwarded to a TCE, Trace Collector Entity.

In some embodiments where the wireless communication network is a New Radio (NR) network, QoE management collects not only the experience parameters of streaming services, but also collects the typical performance requirements of diverse services (e.g., Augmented Reality/Virtual Reality services and Ultra reliable Low Latency Communications services). Based on requirements of services, some embodiments provide more adaptive QoE management schemes that enable network intelligent optimization to satisfy user experience for diverse services.

The measurements may be initiated towards the radio access network (RAN) in a management-based manner, i.e., from an O&M node in a generic way, e.g., for a group of UEs, or they may also be initiated in a signaling-based manner, i.e., initiated from CN to RAN, e.g., for a single UE. The configuration of the measurement includes the measurement details, which is encapsulated in a container that is transparent to RAN.

When initiated via the core network, the measurement is started towards a specific UE. For the LTE case, the “TRACE START” S1AP message is used, which carries, among others, the details about the measurement configuration the application should collect (in the “Container for application layer measurement configuration” IE, transparent to the RAN) and the details to reach the trace collection entity to which the measurements should be sent.

The RAN is not aware of when the streaming session is ongoing and the UE Access Stratum (AS) is also not aware of when the measurements are ongoing. It is heretofore an implementation decision when RAN stops the measurements. As one example, it may be done when the UE has moved outside the measured area. In some embodiments, the QoE measurements heretofore may be kept for the whole session, even during a handover situation.

Some embodiments handle QoE measurement in a way based on that described above in the context of a UTRAN network.

According to some embodiments, the network configures QoE measurement in the UE by sending the UE a “Measurement Control” RRC message containing “Application layer measurement configuration” Information Element (IE). The content of the “Application layer measurement configuration” IE may be represented in the table below.

| | | | | | |
|---|---|---|---|---|---|
| Information | | | | | |
| Element/Group | | | Type and | Semantics | |
| name | Need | Multi | reference | description | Version |

| | | | |
|---|---|---|---|
| Container for | MP | Octet string | REL-14 |
| application | | (1 . . . 1000) | |
| layer | | | |
| measurement | | | |
| configuration | | | |
| Service type | MP | Enumerated | REL-15 |
| | | (QoEStreaming, | |
| | | QoEMTSI) | |

In some embodiments, the UE may send QoE measurement results using the “Measurement Report” RRC message and including the “Application layer measurement reporting” IE. The UE may also perform a Cell Update with cause “application layer measurement report available” in order to initiate the transfer of application layer measurement report. In one embodiments, the signalling radio bearer RB4 shall be used for the MEASUREMENT REPORT message carrying the IE “Application layer measurement reporting”.

The content of the “Application layer measurement reporting” IE may be represented in the table below:

| | | | | | |
|---|---|---|---|---|---|
| Information | | | | | |
| Element/Group | | | Type and | Semantics | |
| name | Need | Multi | reference | description | Version |

| | | | |
|---|---|---|---|
| Container for | MP | Octet | REL-14 |
| application | | string | |
| layer | | (1 . . . 8000) | |
| measurement | | | |
| reporting | | | |
| Service type | MP | Enumerated | REL-15 |
| | | (QoEStreaming, | |
| | | QoEMTSI) | |

Consider now QoE measurement in some embodiments based on E-UTRAN.

In one or more such embodiments, an “Application layer measurement reporting” procedure informs E-UTRAN about an application layer measurement report. A UE capable of application layer measurement reporting in RRC_CONNECTED may initiate the procedure when configured with application layer measurement, i.e., when measConfigAppLayer has been configured by E-UTRAN Upon initiating the procedure, the UE shall perform a number of actions if configured with application layer measurement, and SRB4 is configured, and the UE has received application layer measurement report information from upper layers. These actions include setting the measReportAppLayerContainer in the MeasReportAppLayer message to the value of the application layer measurement report information, setting the serviceType in the MeasReportAppLayer message to the type of the application layer measurement report information, and submitting the MeasReportAppLayer message to lower layers for transmission via SRB4.

Consider now QoE measurement configuration setup and release in embodiments based on E-UTRAN. The RRCConnectionReconfiguration message in this regard is used to reconfigure the UE to setup or release the UE for Application Layer measurements. This is signaled in the measConfigAppLayer-15 IE within the “OtherConfig” IE.

The setup includes the transparent container measConfigAppLayerContainer which specifies the QoE measurement configuration for the Application of interest and the serviceType IE to indicates the Application (or service) for which the QoE measurements are being configured. Supported services may for example include streaming and MTSI.

```
      Below are the details for the measConfigAppLayer IE.
measConfigAppLayer-r15  CHOICE {
  release  NULL,
  setup  SEQUENCE{
      measConfigAppLayerContainer-r15  OCTET STRING (SIZE(1 .. 1000)),
      serviceType-r15  ENUMERATED {qoe, qoemtsi, spare6,
                                        spare5, spare4, spare3, spare2, spare1}
}
```

measConfigAppLayerContainer
The field contains configuration of application layer measurements
serviceType
Indicates the type of application layer measurement.
Value qoe indicates Quality of Experience Measurement
Collection for streaming services, value qoemtsi indicates
Enhanced Quality of Experience Measurement Collection for MTSI.

In some embodiments, the MeasReportAppLayer RRC message is used by the UE to send to the E-UTRAN node the QoE measurement results of an Application (or service). The service for which the report is being sent is indicated in the “serviceType” IE.

Below are the details for the MeasReportAppLayer message, sent using Signalling Radio Bearer, SRB4 according to some embodiments.

MeasReportAppLayer message

```
-- ASN1START
MeasReportAppLayer-r15 ::=  SEQUENCE {
      criticalExtensions  CHOICE {
            measReportAppLayer-r15  MeasReportAppLayer-r15-IEs,
            criticalExtensionsFuture   SEQUENCE { }
      }
}
MeasReportAppLayer-r15-IEs ::=   SEQUENCE {
      measReportAppLayerContainer-r15  OCTET STRING (SIZE(1 .. 8000))  OPTIONAL,
      serviceType-r15  ENUMERATED {qoe, qoemtsi, spare6, spare5,
                                      spare4, spare3, spare2, spare1} OPTIONAL,
      nonCriticalExtension  MeasReportAppLayer-v1590-IEs OPTIONAL
}
MeasReportAppLayer-v1590-IEs ::= SEQUENCE {
      lateNonCriticalExtension  OCTET STRING OPTIONAL,
      nonCritical Extension  SEQUENCE { }  OPTIONAL
}
-- ASN1STOP
```

MeasReportAppLayer field descriptions

measReportAppLayerContainer
The field contains container of application layer measurements
serviceType
Indicates the type of application layer measurement.
Value qoe indicates Quality of Experience Measurement
Collection for streaming services, value qoemtsi indicates
Quality of Experience Measurement Collection for MTSI.

### Full Configuration

In some embodiments, as part of handover preparation to a target node, the source node sends the current UE configuration to the target node in the HANDOVER REQUEST message, e.g., see 3GPP TS 38.423 v16.3.0. The target node prepares a target configuration for the UE based on the current configuration and the target node's and the UE's capabilities. This target configuration is an example of the target configuration 16-2 in FIG. 1. The target configuration in this example is sent from the target node in a HANDOVER REQUEST ACKNOWLEDGE message to the source node and onwards to the UE in RRCReconfiguration, as an example of the message 26 in FIG. 1. As a streamlined option, the target configuration can be provided as a so-called delta-configuration, indicating only the differences from the UE's current configuration in the source cell.

However, if the target node does not recognize something in the UE's current configuration, it is due to that the target node does not support some feature which the source node supports. In such case, the target node will trigger a full configuration, meaning that the UE will discard the current configuration and make a new configuration from scratch, e.g., according to 3GPP TS 38.331 v16.2.0 chapter 5.3.5.11. This may also be applicable for the case where the target node does not support QoE measurements, or does not support QoE measurements of a certain type which the source node supports and which the UE is configured with.

In case of mobility when the UE is configured with a QoE configuration, if the target RAN node does not support the RRC protocol and features configured by the source RAN node, the target RAN node may be unable to understand the UE configuration provided by the source RAN node. This may include the QoE configuration which comes as part of otherConfig IE, contained in the RRC Reconfiguration signal. In this case, the target RAN node will use the full configuration (or fullConfig in RRC TS 38.331 jargon) option to reconfigure the UE for reconfiguration with sync or handover or a re-establishment procedure. Full configuration option includes an initialization of the radio configuration, which makes the procedure independent of the configuration used in the source cell. In this context, if the RAN node sends a full configuration to the UE as part of RRC reconfiguration, the UE according to some embodiments herein informs the upper layers (e.g., application layer) to remove the QoE configuration. That is, upon reception of a full configuration, the UE according to some embodiments clears all the radio configuration and also performs one or more actions to cancel the QoE configuration at upper layers.

For example, some embodiments send a signal or an indication from the UE RRC layer to the upper layers of the UE (e.g., application layer), to cancel or clear or suspend one or more QoE configurations configured to the UE. This signal or indication is one example of the instruction 30 in FIG. 1. Some embodiments thereby provide the possibility for the UE to release/delete/cancel the QoE measurement from the upper layers of the UE when the RAN node (e.g., target RAN node) does not support the QoE measurements. In some embodiments, the UE can also choose to keep the QoE measurement configuration for a limited time, e.g., in a suspended state, even in a cell where it is not supported, to be able to resume the QoE measurement configuration if the UE within the limited time reconnects to the source cell of a handover or successfully re-establishes the connection in another cell which supports the QoE measurement configuration.

Some embodiments alternatively or additionally apply in cases where a full Configuration is issued in RRC Resume, when the RRC Resume is attempted towards a RAN node that did not host the UE Context prior to RRC Resume execution.

Some embodiments alternatively or additionally apply in cases where, as part of the QoE configuration, one or more options of the QoE configuration (e.g., the serviceType) is not supported in the target RAN node.

Some embodiments alternatively or additionally apply in cases where the full Configuration is not included in the RRC Reconfiguration and the QoE configuration currently configured for the UE is not supported in the target RAN node.

More particularly, in some embodiments, the UE RRC layer signals a first indication to upper layers (e.g., at least one application), as an example of the instruction 30 in FIG. 1. In one embodiment, the first indication indicates to the upper layers to release the available QoE measurement configurations that are configured previously. In another embodiment, the first indication sent to the upper layer indicates to the upper layers to suspend the QoE configuration and corresponding QoE measurements until it receives a second indication from the RRC layer. In this case, the second indication may indicate to resume the QoE measurement configuration and the corresponding QoE measurements report. Or, the second indication may indicate to delete the QoE measurement configuration and the corresponding QoE measurement reports.

From the perspective of the upper layers, then, the application layer can release the QoE configurations and the corresponding QoE measurement reports upon reception of the first indication (e.g., release command) from the UE RRC layer that is initiated due to the reception of a Full Configuration as part of RRCReconfiguration or RRCResumeRequest from the RAN node. Or, the application layer can suspend the QoE configurations and the corresponding QoE measurement reports upon reception of the first indication (e.g., suspend command) from the UE RRC layer that is initiated due to the reception of a Full Configuration as part of RRC Reconfiguration from the RAN node.

In some embodiments, the application layer can send a signal acknowledging or unacknowledging the requested action received as part of the first indication from the RRC layer.

If Full Configuration is used in RRC Resume, the scenario of RRC resume towards the same RAN node is different compared to the scenario of RRC resume towards a different RAN node. For the case of RRC Resume including Full Configuration and attempted towards a different RAN node, the Full Configuration should result in discarding application layer measurement configuration and application layer report information. For the case of RRC Resume including Full Configuration and attempted towards the same RAN node, the Full Configuration should NOT result in discarding application layer measurement configuration and application layer report information.

Releasing QoE Configuration Upon Reception of Delta Configuration from RAN Nodes

In some embodiments, the same solution as described above applies if the RRCReconfiguration does not include the full configuration, and according to the target UE configuration indicated in the RRC Reconfiguration, it follows that the QoE configuration with which the UE is configured is not fully supported (e.g., one or more service types are not supported in the target RAN node).

An example of this scenario can be an RRCReconfiguration not including the fullConfig with the UE connected to 5GC (i.e., delta signalling during intra 5GC handover).

The lack of full support for the UE's QoE configuration could be indicated by the target node in various ways. It could be a flag indicating lack of full support. It could be a delta-configuration where the non-supported configuration aspects/parts are removed. Or it could be a full configuration which “reconstructs” the UE's old configuration with the only difference being that the non-supported aspects/parts have been removed.

As other options, a target node in some embodiments may provide a full configuration which not only removes parts of the old configuration, but replaces them with new parts or adds other aspects to the QoE measurement configuration. This may involve, e.g., other parameters to be collected/measured or another format of the reports to be sent or another means for transmission of the report(s).

Handling in Case of Multiple Concurrent QoE Configurations Configured at a UE

In another variant, if the UE is configured with multiple QoE configurations, the reception of full configuration during RRC Resume towards a different RAN node results in discarding of only those application layer measurement configurations that cannot be supported by the target node. The remaining application layer measurement configurations (that can be supported by the target node) are preserved. In other words, the configuration release command proposed above is applied partially, i.e., only to application layer measurement configurations that cannot be supported by the target node. In the context of this variant, the signaling proposed above (as an example of the instruction 30 in FIG. 1) is enhanced with an indication of which exact QoE configurations are discarded.

In the above, multiple QoE configurations may mean e.g., different configurations for different service types, or different types of measurements for the same service type, or any combination thereof. This is a non-limiting example.

In a similar variant, no QoE configuration is released at the application layer, but the RRC layer passes to the application layer a reconfiguration of the application layer's QoE measurement configuration. This may for instance include that certain QoE metric parameter(s) is(are) excluded or that the requested reporting format is changed.

As yet another similar variant, no QoE configuration is released at the application layer, but the RRC layer passes to the application layer a replacement configuration, i.e., a new configuration to replace the old configuration, wherein the new configuration is fully supported by the new gNB/eNB.

### Other Embodiments

In one embodiment, upon reception of the full configuration (fullConfig), the RRC layer in the UE starts a timer and if the timer expires, the RRC layer instructs (e.g., via the instruction 30) the application layer to delete the QoE measurement and reporting configuration and any QoE measurement data collected in accordance with the QoE measurement and reporting configuration. If the UE reconnects to the source cell (e.g., through handover or connection re-establishment), or successfully re-establishes the connection in another cell (where the UE's QoE measurement and reporting configuration is supported), before the timer expires, the RRC layer stops the timer (and refrains from instructing the application layer to delete the QoE measurement and reporting configuration and collected QoE measurement data). The timer's start value may be standardized or configured, either via the broadcast system information or via dedicated control signaling, e.g., RRC signaling, e.g., in the same message as the configuration of the QoE measurement and reporting.

In another embodiment, after receiving the full configuration (fullConfig), when the UE successfully connects to a target cell which does not support the UE's QoE measurement and reporting configuration, the RRC layer instructs the application layer to delete the QoE measurement and reporting configuration and any QoE measurement data collected in accordance with the QoE measurement and reporting configuration.

In yet another embodiment, after or in conjunction with receiving the full configuration (fullConfig), when the UE disconnects from a source cell in conjunction with a switch or an attempt to switch to a cell that does not support the UE's QoE measurement and reporting configuration, the RRC layer instructs the application layer to delete the QoE measurement and reporting configuration and any QoE measurement data collected in accordance with the QoE measurement and reporting configuration.

In yet another embodiment, upon reception of the full configuration (fullConfig), the RRC layer in the UE instructs the application layer to suspend all or parts of the application layer QoE measurement and reporting configuration and any associated actions (such as collection of QoE measurement data or reporting of collected QoE measurement data). Then, if/when the UE successfully connects to the target cell, the RRC layer instructs the application layer to delete the QoE measurement and reporting configuration and any QoE measurement data collected in accordance with the QoE measurement and reporting configuration.

In yet another embodiment, upon reception of the full configuration (fullConfig), the RRC layer in the UE starts a timer and instructs the application layer to suspend all or parts of the application layer QoE measurement and reporting configuration and any associated actions (such as collection of QoE measurement data or reporting of collected QoE measurement data). Then, if the time expires, the RRC layer instructs the application layer to delete the QoE measurement and reporting configuration and any QoE measurement data collected in accordance with the QoE measurement and reporting configuration. But if the UE, before the timer expires, reconnects to the source cell (e.g., through handover or connection re-establishment), or successfully re-establishes the connection in another cell (where the UE's QoE measurement and reporting configuration is supported), the RRC layer stops the timer and instructs the application layer to resume the suspended QoE measurement and reporting configuration and associated actions.

In yet another embodiment, upon reception of the full configuration, or upon disconnecting from the source cell (after receiving the full configuration), or upon successful connection to a target node (after receiving the full configuration), the RRC layer in the UE instructs the application layer to start a timer and suspend all or parts of the application layer QoE measurement and reporting configuration and any associated actions (such as collection of QoE measurement data or reporting of collected QoE measurement data) when/if the timer expires. The application layer is further instructed to delete the QoE measurement and reporting configuration and any QoE measurement data collected in accordance with the QoE measurement and reporting configuration when/if the timer expires. If the UE subsequently reconnects to the source cell, e.g., through handover or connection re-establishment), or successfully re-establishes the connection in another cell (where the UE's QoE measurement and reporting configuration is supported), the RRC layer instructs the application layer to stop the timer and resume the suspended QoE measurement and reporting configuration and associated actions. To facilitate this operation, the RRC layer may start and maintain a timer that corresponds to the timer started at the application layer, so that the RRC layer does not instruct the application layer to resume the suspended QoE measurement and reporting configuration and associated actions, if the timer has expired (since the QoE measurement and reporting configuration and any associated collected QoE measurement data have already been deleted at the application layer).

As one option, in the above embodiment where the application layer is instructed to suspend all or parts of the application layer QoE measurement and reporting configuration and any associated actions, the suspension, in some embodiments, comprises suspension of all of the QoE measurement and reporting configuration and all associated actions.

As another option, in the above embodiment where the application layer is instructed to suspend all or parts of the application layer QoE measurement and reporting configuration and any associated actions, the suspension, in some other embodiments, comprises suspension of only the reporting of collected QoE measurement data, while other configuration parts and actions—in particular the collection of QoE measurement data—are not suspended.

The values of the timers described in the embodiments above may be standardized or configured by the network. If configured by the network, the timer value(s) may be conveyed using broadcast system information or using dedicated control signaling (e.g., RRC signaling), e.g., included in the same message as the QoE measurement and reporting configuration when this is conveyed to the UE.

In all of the above embodiments involving the UE possibly reconnecting to the source cell or successfully re-establish its connection in another cell where the UE's QoE measurement and reporting configuration is supported, the source node may facilitate resumption (or continued use) of the QoE measurement and reporting configuration (including QoE measurement data collection and reporting of collected QoE measurement data) by retaining the QoE measurement and reporting configuration associated with the UE some time after the UE has left the source cell.

### An Example Implementation

A non-limiting 3GPP RRC TS 38.331 example implementation of some embodiments herein is highlighted in the following:

5.3.5.11 Full configuration

The UE shall:
1> release/clear all current dedicated radio configurations except for the following:
   the MCG C-RNTI;
   the AS security configurations associated with the master key;
1> inform upper layers to clear the stored application layer measurement configuration;
1> discard received application layer measurement report information from upper layers;
1> consider itself not to be configured to send application layer measurement report.
NOTE 1: Radio configuration is not just the resource configuration but includes other configurations like MeasConfig. In case NR-DC or NE-DC is configured, this also includes the entire NR or E-UTRA SCG configuration which are released according to the MR-DC release procedure as specified in 5.3.5.10. The radio configuration does not include SRB1/SRB2 configurations and DRB configurations as configured by radioBearerConfig or radioBearerConfig2.
NOTE 1a: For NR sidelink communication, the radio configuration includes the sidelink RRC configuration received from the network, but does not include the sidelink RRC reconfiguration and sidelink UE capability received from other UEs via PC5-RRC. In addition, the UE considers the new NR sidelink configurations as full configuration, in case of state transition and change of system information used for NR sidelink communication.
1> if the spCellConfig in the masterCellGroup includes the reconfigurationWithSync (i.e., SpCell change):
   2> release/clear all current common radio configurations;
   2> use the default values specified in 9.2.3 for timers T310, T311 and constants N310, N311;
1> else (full configuration after re-establishment or during RRC resume):
   2> use values for timers T301, T310, T311 and constants N310, N311, as included in ue-TimersAndConstants received in SIB1;
1> apply the default L1 parameter values as specified in corresponding physical layer specifications except for the following:
   parameters for which values are provided in SIB1;
1> apply the default MAC Cell Group configuration as specified in 9.2.2;
1> for each srb-Identity value included in the srb-ToAddModList (SRB reconfiguration):
   2> apply the default SRB configuration defined in 9.2.1 for the corresponding SRB;
NOTE 2: This is to get the SRBs (SRB1 and SRB2 for reconfiguration with sync and SRB2 for resume and reconfiguration after re-establishment) to a known state from which the reconfiguration message can do further configuration.
1> for each pdu-Session that is part of the current UE configuration:
   2> release the SDAP entity (clause 5.1.2 in TS 37.324 [24]);
   2> release each DRB associated to the pdu-Session as specified in 5.3.5.6.4;
NOTE 3: This will retain the pdu-Session but remove the DRBs including drb-identity of these bearers from the current UE configuration. Setup of the DRBs within the AS is described in clause 5.3.5.6.5 using the new configuration. The pdu-Session acts as the anchor for associating the released and re-setup DRB. In the AS the DRB re-setup is equivalent with a new DRB setup (including new PDCP and logical channel configurations).
1> for each pdu-Session that is part of the current UE configuration but not added with same pdu-Session in the drb-ToAddModList:
   2> if the procedure was triggered due to reconfiguration with sync:
      3> indicate the release of the user plane resources for the pdu-Session to upper layers after successful reconfiguration with sync;
   2> else:
      3> indicate the release of the user plane resources for the pdu-Session to upper layers immediately;

In some embodiments, the above applies only to the QoE configurations subject to release/deletion/cancellation. The corresponding implementation can be enabled by indicating the configurations that are subject to release/deletion/cancellation.

Some embodiments may provide one or more of the following technical advantage(s). Some embodiments ensure that the QoE configuration is released from the upper layers of the UE and the ongoing measurement or the new measurements at application layer is stopped upon reception of full configuration from the RAN nodes as part of RRC reconfiguration. Alternatively or additionally, some embodiments help the UE's RRC layer to stop reception of the QoE measurement reports from the UE's application layer when there is no radio signaling bearer configured by the network for reporting the QoE measurement reports to the network.

Note the following regarding terminology used to describe one or more embodiments herein. The terms “wireless device”, “wireless communication device”, “UE”, “terminal equipment” and “wireless terminal” are used interchangeably. The terms MCE and TCE are used interchangeably. A “RAN node” can be a gNB, eNB, gNB-CU, gNB-CU-CP, eNB-CU, eNB-CU-CP, IAB-donor, IAB-donor-CU, IAB-donor-CU-CP. Here, CP stands for control plane, and IAB stands for integrated access backhaul.

The terms “application layer measurement configuration” and “application measurement configuration” are used interchangeably. The terms “QoE measurement configuration” and “QoE measurement and reporting configuration” are used interchangeably and are examples of an “application layer measurement configuration”.

In some embodiments, the radio network layer 22 as used herein is a layer that is in a protocol stack at the wireless device 12 and that handles functions, configurations, actions or communication related to, or associated with, radio access to a wireless communication network, e.g., via a radio access network (RAN) of the wireless communication network. In some contexts or examples herein, the terms “modem”, “radio layer”, “RRC layer” and “radio network layer” are used interchangeably. The terms access stratum and radio layer are used interchangeably.

In some embodiments, the application layer 24 as used herein hosts functions and/or entities (e.g. ‘applications’ or ‘services’) that are not associated with functionality pertaining specifically to the wireless or cellular communication network that the functions and/or entities use for communication. In one embodiment, the application layer 24 is implemented on top of a Transport Layer (e.g., hosting transport protocols such as TCP, UDP, SCTP, or RTP), which in turn is implemented on top of a Network Layer (e.g., hosting the Internet Protocol, IP). Here, TCP refers to the Transmission Control Protocol, UDP refers to the User Datagram Protocol, SCTP refers to the Stream Control Transmission Protocol, and RTP refers to the Real-time Transport Protocol. All references to the application layer are with respect to the application layer of the wireless device (since RAN nodes do not have an application layer).

Note further that some embodiments herein apply to UMTS, LTE and/or NR. Note also that some embodiments apply to both signaling- and management-based minimization of drive test (MDT) and QoE measurements. Furthermore, note that some embodiments pertain to any of the procedures where fullConfig is received, e.g., at least RRC Resume, Reconfiguration with sync or RRC Reestablishment.

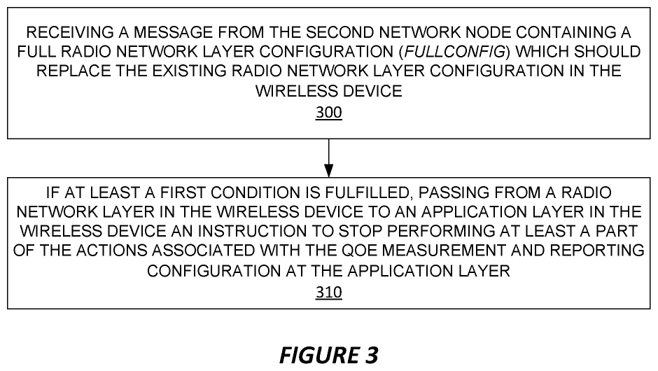

Generally, FIG. 3 shows a method according to some embodiments. The method is performed in a wireless device 12 for managing a QoE measurement and reporting configuration when moving from a first cell, controlled by a first network node 14-1, to a second cell, controlled by a second network node 14-2. Here, the second cell and the second network node 14-2 lacks full support for the QoE measurement and reporting configuration the wireless device 12 has obtained from the first network node 14-1 in the first cell. And the QoE measurement and reporting configuration is a part of a radio network layer configuration. In this context, the method comprises receiving a message from the second network node 14-2 containing a full radio network layer configuration (fullConfig) which should replace the existing radio network layer configuration in the wireless device 12 (Block 300). The method further comprise, if at least a first condition is fulfilled, passing from a radio network layer 22 in the wireless device 12 to an application layer 24 in the wireless device 12 an instruction to stop performing at least a part of the actions associated with the QoE measurement and reporting configuration at the application layer 24 (Block 310).

In some embodiments, the at least first condition comprises that the wireless device 12 has successfully connected to the second network node 14-2 in the second cell.

In some embodiments, the method further comprises starting a first timer upon reception of the message 26 from the second network node 14-2. In this case, the at least first condition comprises expiration of the first timer.

In some embodiments, the instruction 30 passed from the radio network layer 22 to the application layer 24 in the wireless device 12 comprises instructing the application layer 24 to delete the QoE measurement and reporting configuration at the application layer 24 and delete any measurement data collected in accordance with the QoE measurement and reporting configuration at the application layer 24.

In some embodiments, the at least first condition comprises that the wireless device 12 has disconnected from the first cell.

In some embodiments, the method further comprises that, prior to successfully connecting to the second cell or prior to starting the timer, the radio network layer 22 passes an instruction 30 to the application layer 24 in the wireless device 12, instructing the application layer 24 to suspend at least parts of the application layer QoE measurement and reporting configuration and associated actions. In one or more of these embodiments, the instructed suspension comprises suspension of all of the application layer QoE measurement and reporting configuration and any associated actions. In one or more of these embodiments, the instructed suspension comprises suspension of the QoE measurement reporting while leaving any collection of QoE measurement data in accordance with the QoE measurement configuration at the application layer 24 unsuspended. In one or more of these embodiments, the method further comprises that if the wireless device 12 reconnects to the first network node 14-1 in the first cell without the at least first condition having been fulfilled, the radio network layer 22 passes an instruction 30 to the application layer 24 in the wireless device 12, instructing the application layer 24 to resume (i.e. reactivate from suspension) the suspended all or parts of the application layer QoE measurement and reporting configuration and any suspended associated actions. In one or more of these embodiments, the method further comprises that if the wireless device 12 successfully re-establishes a connection in a third cell without the at least first condition having been fulfilled, the radio network layer 22 passes an instruction 30 to the application layer 24 in the wireless device 12, instructing the application layer 24 to resume (i.e. reactivate from suspension) the suspended all or parts of the application layer QoE measurement and reporting configuration and any suspended associated actions.

In some embodiments, the instruction 30 passed from the radio network layer 22 to the application layer 24 in the wireless device 12 comprises instructing the application layer 24 to start a second timer and, if the timer expires, delete the QoE measurement and reporting configuration at the application layer 24 and delete any measurement data collected in accordance with the QoE measurement and reporting configuration at the application layer 24. In one or more of these embodiments, the method further comprises that the instruction 30 passed from the radio network layer 22 to the application layer 24 in the wireless device 12 comprises instructing the application layer 24 to suspend at least parts of the application layer QoE measurement and reporting configuration and associated actions in conjunction with starting of the second timer. In one or more of these embodiments, the instructed suspension comprises suspension of all of the application layer QoE measurement and reporting configuration and any associated actions. In one or more of these embodiments, the instructed suspension comprises suspension of the QoE measurement reporting while leaving any collection of QoE measurement data in accordance with the QoE measurement configuration at the application layer 24 unsuspended. In one or more of these embodiments, the method further comprises that if the wireless device 12 reconnects to the first network node 14-1 in the first cell without the at least first condition having been fulfilled, the radio network layer 22 passes an instruction 30 to the application layer 24 in the wireless device 12, instructing the application layer 24 to stop the second timer and resume (i.e. reactivate from suspension) the suspended all or parts of the application layer QoE measurement and reporting configuration and any suspended associated actions. In one or more of these embodiments, the method further comprises that if the wireless device 12 successfully re-establishes a connection in a third cell without the at least first condition having been fulfilled, the radio network layer 22 passes an instruction 30 to the application layer 24 in the wireless device 12, instructing the application layer 24 to stop the second timer and resume (i.e. reactivate from suspension) the suspended all or parts of the application layer QoE measurement and reporting configuration and any suspended associated actions. In one or more of these embodiments, the method further comprises that the radio network layer 22 in the wireless device 12, in conjunction with the passing of the instruction 30 to the application layer 24 in the wireless device 12, starts a third timer at the same value as the second timer and further comprising that the radio network layer 22 in the wireless device 12 passes the instruction 30 to the application layer 24 to resume the QoE measurement and reporting configuration and any associated actions at the application layer 24 only if the third timer has not expired.

In some embodiments, the method further comprises involving at least one of the first timer, the second timer and the third timer, wherein the start value or expiration value of one or more of the first timer, the second timer and the third timer is/are configured in the wireless device 12 by a network node. In one or more of these embodiments, the network node is the first network node 14-1. In one or more of these embodiments, the configuration of start or expiration value(s) is conveyed using dedicated control signaling together with the QoE measurement and reporting configuration. In one or more of these embodiments, the configuration of start or expiration value(s) is conveyed using common control signaling in the form of system information.

In some embodiments, the method further comprises involving at least one of the first timer, the second timer and the third timer, wherein the start value or expiration value of one or more of the first timer, the second timer and the third timer is/are hardcoded in a standard specification.

In some embodiments, the radio network layer 22 is a Radio Resource Control (RRC) layer.

In some embodiments, each of the first network node 14-1 and the second network node 14-2 is either a gNB or an eNB.

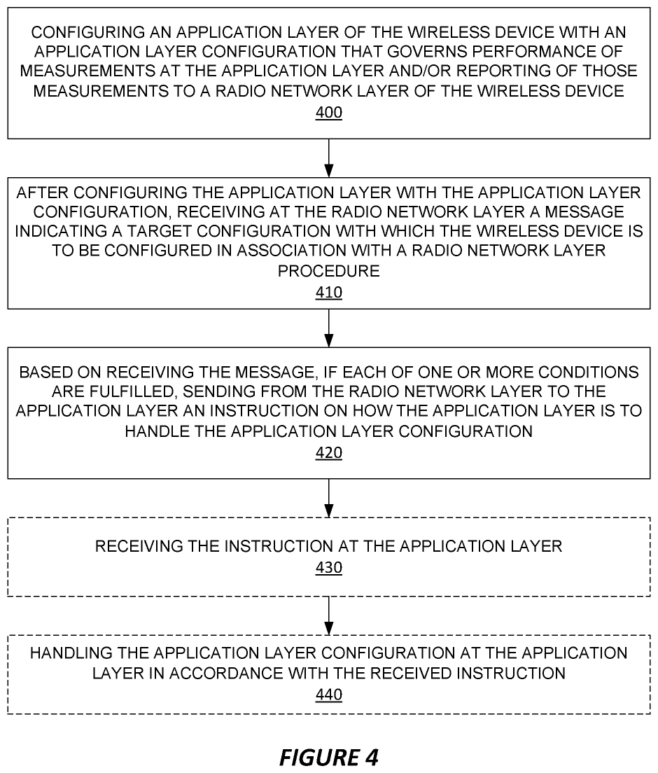

FIG. 4 depicts a method performed by a wireless device 12 in accordance with other embodiments. The method includes configuring an application layer 24 of the wireless device 12 with an application layer configuration 20-1 that governs performance of measurements at the application layer 24 and/or reporting of those measurements to a radio network layer 22 of the wireless device 12 (Block 400). The method further includes, after configuring the application layer 24 with the application layer configuration 20-1, receiving at the radio network layer 22 a message 26 indicating a target configuration 16-2 with which the wireless device 12 is to be configured in association with a radio network layer procedure (Block 410). The method also includes, based on receiving the message 26, if each of one or more conditions are fulfilled, sending from the radio network layer 22 to the application layer 24 an instruction 30 on how the application layer 24 is to handle the application layer configuration 20-1 (Block 420).

In some embodiments, the method further comprises receiving the instruction at the application layer 24 (Block 430), and handling the application layer configuration 20-1 at the application layer 24 in accordance with the received instruction 30 (Block 440).

In some embodiments, the one or more conditions include a condition that the message 26 indicates a full configuration option is applicable for the message 26. In this case, according to the full configuration option the wireless device 12 is to be configured with the target configuration 16-2 independent of any previous configuration of the wireless device 12.

In some embodiments, the radio network layer procedure is a procedure for handing over a radio network layer connection of the wireless device 12 from a source network node 14-1 to a target network node 14-2) or a procedure for resuming or re-establishing at a target network node 14-2 a radio network layer connection previously established at a source radio network node 14-1. In this case, the target configuration 16-2 is a configuration with which the wireless device 12 is to be configured for being served by the target network node 14-2.

In some embodiments, the one or more conditions include a condition that a target network node 14-2 of the radio network layer procedure lacks full support of the application layer configuration 20-1.

In some embodiments, the one or more conditions include a condition that a target network node 14-2 of the radio network layer procedure and a source network node 14-1 of the radio network layer procedure are different network nodes.

In some embodiments, the method further comprises starting a timer upon reception of the message 26. In this case, the one or more conditions include a condition that the timer expires. In one or more of these embodiments, the method further comprises, after successfully executing the radio network layer procedure to a first target network node, stopping the timer upon successfully executing another radio network layer procedure to a second target network node.

In some embodiments, the one or more conditions include a condition that the wireless device 12 successfully connects to a target network node or cell of the radio network layer procedure.

In some embodiments, the one or more conditions include a condition that the wireless device 12 disconnects from a source network node or cell of the radio network layer procedure.

In some embodiments, the instruction 30 on how the application layer 24 is to handle the application layer configuration 20-1 is an instruction 30 that the application layer 24 is to delete or suspend at least a part of the application layer configuration 20-1. Additionally or alternatively, the instruction 30 on how the application layer 24 is to handle the application layer configuration 20-1 is an instruction 30 that the application layer 24 is to reconfigure or replace at least a part of the application layer configuration 20-1. Additionally or alternatively, the instruction 30 on how the application layer 24 is to handle the application layer configuration 20-1 is an instruction 30 that the application layer 24 is to stop or suspend performance of one or more actions governed by the application layer configuration 20-1. In one or more of these embodiments, the at least a part of the application layer configuration 20-1 that is to be deleted, suspended, reconfigured, or replaced according to the instruction 30 is a part that governs reporting of the measurements to the radio network layer 22 and excludes a part that governs performance of the measurements at the application layer 24. Additionally or alternatively, the one or more actions whose performance is to be stopped or suspended according to the instruction 30 includes reporting of the measurements to the radio network layer 22 and excludes performance of the measurements at the application layer 24.

In some embodiments, the instruction 30 on how the application layer 24 is to handle the application layer configuration 20-1 is an instruction 30 that the application layer 24 is to delete at least some measurement data collected in accordance with the application layer configuration 20-1.

In some embodiments, the instruction 30 on how the application layer 24 is to handle the application layer configuration 20-1 is an instruction 30 that the application layer 24 is to suspend at least a part of the application layer configuration 20-1. In this case, the method further comprises starting a timer upon reception of the message 26, and if the timer expires, sending from the radio network layer 22 to the application layer 24 a further instruction 30 that the application layer 24 is to delete the at least part of the application layer configuration 20-1 that was suspended. In this case, the method further comprises if, after successfully executing the radio network layer procedure to a first target network node, the wireless device 12 successfully executes another radio network layer procedure to a second target network node before the timer expires, sending from the radio network layer 22 to the application layer 24 a further instruction 30 that the application layer 24 is to resume the at least part of the application layer configuration 20-1 that was suspended.

In some embodiments, the instruction 30 on how the application layer 24 is to handle the application layer configuration 20-1 is an instruction 30 that the application layer 24 is to suspend at least a part of the application layer configuration 20-1, that the application layer 24 is to start a timer, and that the application layer 24 is to delete the at least part of the application layer configuration 20-1 that was suspended upon expiration of the timer. In this case, the method further comprises starting a corresponding timer at the radio network layer 22, and if, after successfully executing the radio network layer procedure to a first target network node, the wireless device 12 successfully executes another radio network layer procedure to a second target network node before the corresponding timer expires, sending from the radio network layer 22 to the application layer 24 a further instruction 30 that the application layer 24 is to resume the at least part of the application layer configuration 20-1 that was suspended.

In some embodiments, the application layer 24 is configured with multiple concurrent application layer configurations 20-1. In this case, the instruction 30 indicates to which of the multiple concurrent application layer configurations 20-1 the instruction 30 applies.

In some embodiments, the radio network layer 22 is a radio resource control layer.

In some embodiments, the application layer configuration 20-1 is a quality of experience, QoE, measurement that governs performance of QoE measurements at the application layer 24. Additionally or alternatively, the application layer configuration 20-1 is a reporting configuration reporting of the QoE measurements to the radio network layer 22.

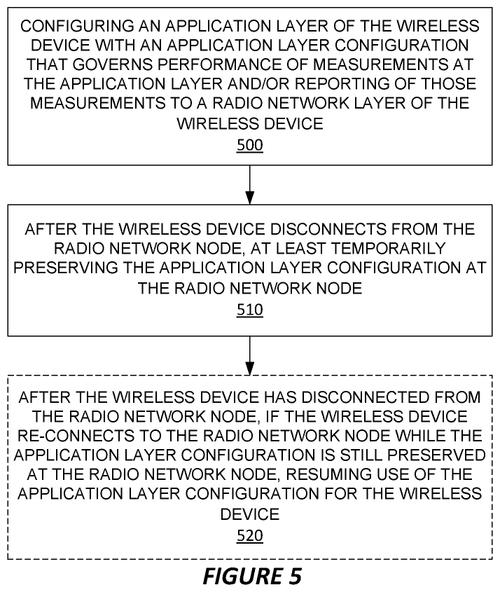

FIG. 5 depicts a method performed by a radio network node 14-1 serving a wireless device 12 in accordance with other particular embodiments. The method includes configuring an application layer 24 of the wireless device 12 with an application layer configuration 20-1 that governs performance of measurements at the application layer 24 and/or reporting of those measurements to a radio network layer 22 of the wireless device (Block 500). The method further comprises, after the wireless device 12 disconnects from the radio network node 14-1, at least temporarily preserving the application layer configuration 20-1 at the radio network node 14-1 (Block 510).

In some embodiments, the method also comprises, after the wireless device 12 has disconnected from the radio network node 14-1, if the wireless device 12 re-connects to the radio network node 14-1 while the application layer configuration 20-1 is still preserved at the radio network node 14-1, resuming use of the application layer configuration 20-1 for the wireless device 12 (Block 520).

In some embodiments, at least temporarily preserving the application layer configuration 20-1 comprises starting a timer upon the wireless device 12 disconnecting from the radio network node 14-1 and preserving the application layer configuration 20-1 until the timer expires. In one or more of these embodiments, the method further comprises stopping the timer upon the wireless device 12 re-connecting to the radio network node 14-1.

In some embodiments, the radio network layer 22 is a radio resource control layer.

In some embodiments, the application layer configuration 20-1 is a quality of experience, QoE, measurement that governs performance of QoE measurements at the application layer 24. Additionally or alternatively, the application layer configuration 20-1 is a reporting configuration that governs reporting of the QoE measurements to the radio network layer 22.

Embodiments herein also include corresponding apparatuses. Embodiments herein for instance include a wireless device 12 configured to perform any of the steps of any of the embodiments described above for the wireless device 12.

Embodiments also include a wireless device 12 comprising processing circuitry and power supply circuitry. The processing circuitry is configured to perform any of the steps of any of the embodiments described above for the wireless device 12. The power supply circuitry is configured to supply power to the wireless device 12.

Embodiments further include a wireless device 12 comprising processing circuitry. The processing circuitry is configured to perform any of the steps of any of the embodiments described above for the wireless device 12. In some embodiments, the wireless device 12 further comprises communication circuitry.

Embodiments further include a wireless device 12 comprising processing circuitry and memory. The memory contains instructions executable by the processing circuitry whereby the wireless device 12 is configured to perform any of the steps of any of the embodiments described above for the wireless device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a radio network node 14-1 configured to perform any of the steps of any of the embodiments described above for the radio network node 14-1.

Embodiments also include a radio network node 14-1 comprising processing circuitry and power supply circuitry. The processing circuitry is configured to perform any of the steps of any of the embodiments described above for the radio network node 14-1. The power supply circuitry is configured to supply power to the radio network node 14-1.

Embodiments further include a radio network node 14-1 comprising processing circuitry. The processing circuitry is configured to perform any of the steps of any of the embodiments described above for the radio network node 14-1. In some embodiments, the radio network node 14-1 further comprises communication circuitry.

Embodiments further include a radio network node 14-1 comprising processing circuitry and memory. The memory contains instructions executable by the processing circuitry whereby the radio network node 14-1 is configured to perform any of the steps of any of the embodiments described above for the radio network node 14-1.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

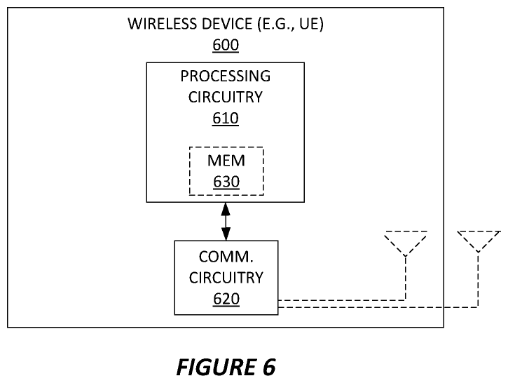

FIG. 6 for example illustrates a wireless device 600 (e.g., wireless device 12) as implemented in accordance with one or more embodiments. As shown, the wireless device 600 includes processing circuitry 610 and communication circuitry 620. The communication circuitry 620 (e.g., radio circuitry) is configured to transmit and/or receive information to and/or from one or more other nodes, e.g., via any communication technology. Such communication may occur via one or more antennas that are either internal or external to the wireless device 600. The processing circuitry 610 is configured to perform processing described above, e.g., in FIG. 3 and/or FIG. 4, such as by executing instructions stored in memory 630. The processing circuitry 610 in this regard may implement certain functional means, units, or modules.

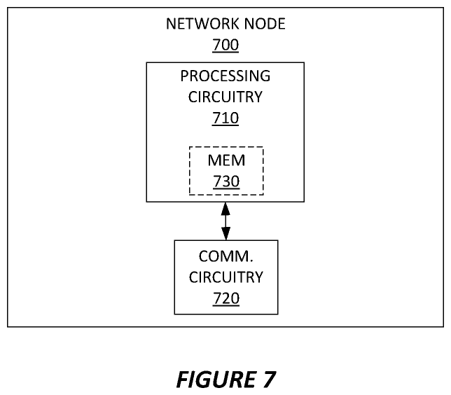

FIG. 7 illustrates a network node 700 (e.g., radio network node 14-1) as implemented in accordance with one or more embodiments. As shown, the network node 700 includes processing circuitry 710 and communication circuitry 720. The communication circuitry 720 is configured to transmit and/or receive information to and/or from one or more other nodes, e.g., via any communication technology. The processing circuitry 710 is configured to perform processing described above, e.g., in FIG. 5, such as by executing instructions stored in memory 730. The processing circuitry 710 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

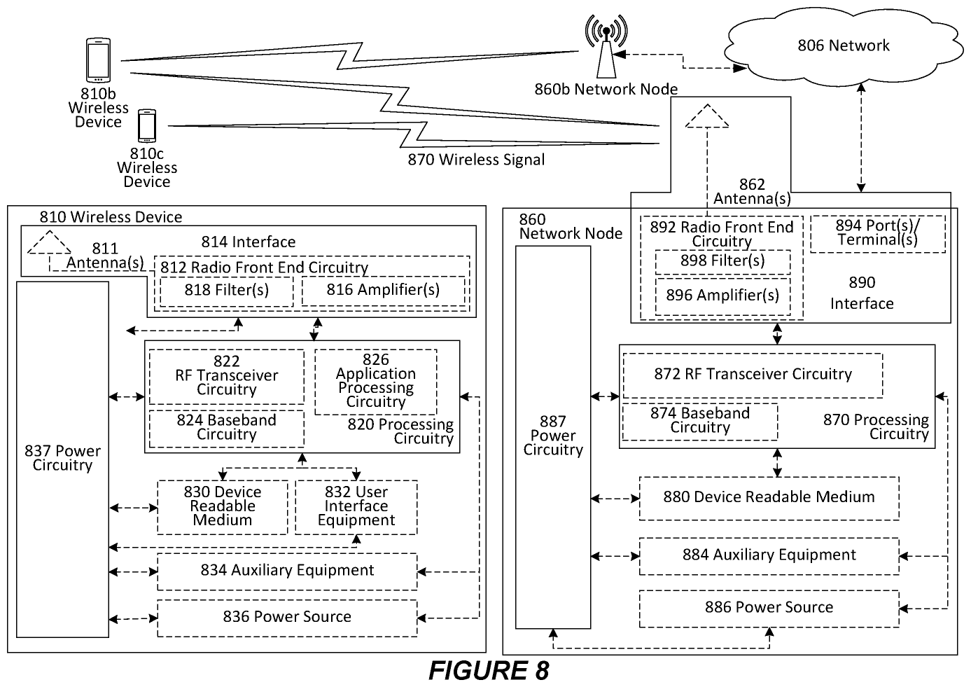

Although the subject matter described herein may be implemented in any appropriate type of system using any suitable components, the embodiments disclosed herein are described in relation to a wireless network, such as the example wireless network illustrated in FIG. 8. For simplicity, the wireless network of FIG. 8 only depicts network 806, network nodes 860 and 860b, and WDs 810, 810b, and 810c. In practice, a wireless network may further include any additional elements suitable to support communication between wireless devices or between a wireless device and another communication device, such as a landline telephone, a service provider, or any other network node or end device. Of the illustrated components, network node 860 and wireless device (WD) 810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 806 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 860 and WD 810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 8, network node 860 includes processing circuitry 870, device readable medium 880, interface 890, auxiliary equipment 884, power source 886, power circuitry 887, and antenna 862. Although network node 860 illustrated in the example wireless network of FIG. 8 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 860 are depicted as single boxes located within a larger box, or nested within multiple boxes, in practice, a network node may comprise multiple different physical components that make up a single illustrated component (e.g., device readable medium 880 may comprise multiple separate hard drives as well as multiple RAM modules).

Similarly, network node 860 may be composed of multiple physically separate components (e.g., a NodeB component and a RNC component, or a BTS component and a BSC component, etc.), which may each have their own respective components. In certain scenarios in which network node 860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 860 may be configured to support multiple radio access technologies (RATs). In such embodiments, some components may be duplicated (e.g., separate device readable medium 880 for the different RATs) and some components may be reused (e.g., the same antenna 862 may be shared by the RATs). Network node 860 may also include multiple sets of the various illustrated components for different wireless technologies integrated into network node 860, such as, for example, GSM, WCDMA, LTE, NR, WiFi, or Bluetooth wireless technologies. These wireless technologies may be integrated into the same or different chip or set of chips and other components within network node 860.

Processing circuitry 870 is configured to perform any determining, calculating, or similar operations (e.g., certain obtaining operations) described herein as being provided by a network node. These operations performed by processing circuitry 870 may include processing information obtained by processing circuitry 870 by, for example, converting the obtained information into other information, comparing the obtained information or converted information to information stored in the network node, and/or performing one or more operations based on the obtained information or converted information, and as a result of said processing making a determination.

Processing circuitry 870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 860 components, such as device readable medium 880, network node 860 functionality. For example, processing circuitry 870 may execute instructions stored in device readable medium 880 or in memory within processing circuitry 870. Such functionality may include providing any of the various wireless features, functions, or benefits discussed herein. In some embodiments, processing circuitry 870 may include a system on a chip (SOC).

In some embodiments, processing circuitry 870 may include one or more of radio frequency (RF) transceiver circuitry 872 and baseband processing circuitry 874. In some embodiments, radio frequency (RF) transceiver circuitry 872 and baseband processing circuitry 874 may be on separate chips (or sets of chips), boards, or units, such as radio units and digital units. In alternative embodiments, part or all of RF transceiver circuitry 872 and baseband processing circuitry 874 may be on the same chip or set of chips, boards, or units In certain embodiments, some or all of the functionality described herein as being provided by a network node, base station, eNB or other such network device may be performed by processing circuitry 870 executing instructions stored on device readable medium 880 or memory within processing circuitry 870. In alternative embodiments, some or all of the functionality may be provided by processing circuitry 870 without executing instructions stored on a separate or discrete device readable medium, such as in a hard-wired manner. In any of those embodiments, whether executing instructions stored on a device readable storage medium or not, processing circuitry 870 can be configured to perform the described functionality. The benefits provided by such functionality are not limited to processing circuitry 870 alone or to other components of network node 860, but are enjoyed by network node 860 as a whole, and/or by end users and the wireless network generally.

Device readable medium 880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 870. Device readable medium 880 may store any suitable instructions, data or information, including a computer program, software, an application including one or more of logic, rules, code, tables, etc. and/or other instructions capable of being executed by processing circuitry 870 and, utilized by network node 860. Device readable medium 880 may be used to store any calculations made by processing circuitry 870 and/or any data received via interface 890. In some embodiments, processing circuitry 870 and device readable medium 880 may be considered to be integrated.

Interface 890 is used in the wired or wireless communication of signalling and/or data between network node 860, network 806, and/or WDs 810. As illustrated, interface 890 comprises port(s)/terminal(s) 894 to send and receive data, for example to and from network 806 over a wired connection. Interface 890 also includes radio front end circuitry 892 that may be coupled to, or in certain embodiments a part of, antenna 862. Radio front end circuitry 892 comprises filters 898 and amplifiers 896. Radio front end circuitry 892 may be connected to antenna 862 and processing circuitry 870. Radio front end circuitry may be configured to condition signals communicated between antenna 862 and processing circuitry 870. Radio front end circuitry 892 may receive digital data that is to be sent out to other network nodes or WDs via a wireless connection. Radio front end circuitry 892 may convert the digital data into a radio signal having the appropriate channel and bandwidth parameters using a combination of filters 898 and/or amplifiers 896. The radio signal may then be transmitted via antenna 862.

Similarly, when receiving data, antenna 862 may collect radio signals which are then converted into digital data by radio front end circuitry 892. The digital data may be passed to processing circuitry 870. In other embodiments, the interface may comprise different components and/or different combinations of components.

In certain alternative embodiments, network node 860 may not include separate radio front end circuitry 892, instead, processing circuitry 870 may comprise radio front end circuitry and may be connected to antenna 862 without separate radio front end circuitry 892. Similarly, in some embodiments, all or some of RF transceiver circuitry 872 may be considered a part of interface 890. In still other embodiments, interface 890 may include one or more ports or terminals 894, radio front end circuitry 892, and RF transceiver circuitry 872, as part of a radio unit (not shown), and interface 890 may communicate with baseband processing circuitry 874, which is part of a digital unit (not shown).

Antenna 862 may include one or more antennas, or antenna arrays, configured to send and/or receive wireless signals. Antenna 862 may be coupled to radio front end circuitry 890 and may be any type of antenna capable of transmitting and receiving data and/or signals wirelessly. In some embodiments, antenna 862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 862 may be separate from network node 860 and may be connectable to network node 860 through an interface or port.

Antenna 862, interface 890, and/or processing circuitry 870 may be configured to perform any receiving operations and/or certain obtaining operations described herein as being performed by a network node. Any information, data and/or signals may be received from a wireless device, another network node and/or any other network equipment. Similarly, antenna 862, interface 890, and/or processing circuitry 870 may be configured to perform any transmitting operations described herein as being performed by a network node. Any information, data and/or signals may be transmitted to a wireless device, another network node and/or any other network equipment.

Power circuitry 887 may comprise, or be coupled to, power management circuitry and is configured to supply the components of network node 860 with power for performing the functionality described herein. Power circuitry 887 may receive power from power source 886.

Power source 886 and/or power circuitry 887 may be configured to provide power to the various components of network node 860 in a form suitable for the respective components (e.g., at a voltage and current level needed for each respective component). Power source 886 may either be included in, or external to, power circuitry 887 and/or network node 860. For example, network node 860 may be connectable to an external power source (e.g., an electricity outlet) via an input circuitry or interface such as an electrical cable, whereby the external power source supplies power to power circuitry 887. As a further example, power source 886 may comprise a source of power in the form of a battery or battery pack which is connected to, or integrated in, power circuitry 887. The battery may provide backup power should the external power source fail. Other types of power sources, such as photovoltaic devices, may also be used.

Alternative embodiments of network node 860 may include additional components beyond those shown in FIG. 8 that may be responsible for providing certain aspects of the network node's functionality, including any of the functionality described herein and/or any functionality necessary to support the subject matter described herein. For example, network node 860 may include user interface equipment to allow input of information into network node 860 and to allow output of information from network node 860. This may allow a user to perform diagnostic, maintenance, repair, and other administrative functions for network node 860.

As used herein, wireless device (WD) refers to a device capable, configured, arranged and/or operable to communicate wirelessly with network nodes and/or other wireless devices.

Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc.

A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 810 includes antenna 811, interface 814, processing circuitry 820, device readable medium 830, user interface equipment 832, auxiliary equipment 834, power source 836 and power circuitry 837. WD 810 may include multiple sets of one or more of the illustrated components for different wireless technologies supported by WD 810, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 810.

Antenna 811 may include one or more antennas or antenna arrays, configured to send and/or receive wireless signals, and is connected to interface 814. In certain alternative embodiments, antenna 811 may be separate from WD 810 and be connectable to WD 810 through an interface or port. Antenna 811, interface 814, and/or processing circuitry 820 may be configured to perform any receiving or transmitting operations described herein as being performed by a WD. Any information, data and/or signals may be received from a network node and/or another WD. In some embodiments, radio front end circuitry and/or antenna 811 may be considered an interface.

As illustrated, interface 814 comprises radio front end circuitry 812 and antenna 811. Radio front end circuitry 812 comprise one or more filters 818 and amplifiers 816. Radio front end circuitry 814 is connected to antenna 811 and processing circuitry 820, and is configured to condition signals communicated between antenna 811 and processing circuitry 820. Radio front end circuitry 812 may be coupled to or a part of antenna 811. In some embodiments, WD 810 may not include separate radio front end circuitry 812; rather, processing circuitry 820 may comprise radio front end circuitry and may be connected to antenna 811. Similarly, in some embodiments, some or all of RF transceiver circuitry 822 may be considered a part of interface 814. Radio front end circuitry 812 may receive digital data that is to be sent out to other network nodes or WDs via a wireless connection. Radio front end circuitry 812 may convert the digital data into a radio signal having the appropriate channel and bandwidth parameters using a combination of filters 818 and/or amplifiers 816. The radio signal may then be transmitted via antenna 811. Similarly, when receiving data, antenna 811 may collect radio signals which are then converted into digital data by radio front end circuitry 812. The digital data may be passed to processing circuitry 820. In other embodiments, the interface may comprise different components and/or different combinations of components.

Processing circuitry 820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 810 components, such as device readable medium 830, WD 810 functionality. Such functionality may include providing any of the various wireless features or benefits discussed herein. For example, processing circuitry 820 may execute instructions stored in device readable medium 830 or in memory within processing circuitry 820 to provide the functionality disclosed herein.

As illustrated, processing circuitry 820 includes one or more of RF transceiver circuitry 822, baseband processing circuitry 824, and application processing circuitry 826. In other embodiments, the processing circuitry may comprise different components and/or different combinations of components. In certain embodiments processing circuitry 820 of WD 810 may comprise a SOC. In some embodiments, RF transceiver circuitry 822, baseband processing circuitry 824, and application processing circuitry 826 may be on separate chips or sets of chips.

In alternative embodiments, part or all of baseband processing circuitry 824 and application processing circuitry 826 may be combined into one chip or set of chips, and RF transceiver circuitry 822 may be on a separate chip or set of chips. In still alternative embodiments, part or all of RF transceiver circuitry 822 and baseband processing circuitry 824 may be on the same chip or set of chips, and application processing circuitry 826 may be on a separate chip or set of chips. In yet other alternative embodiments, part or all of RF transceiver circuitry 822, baseband processing circuitry 824, and application processing circuitry 826 may be combined in the same chip or set of chips. In some embodiments, RF transceiver circuitry 822 may be a part of interface 814. RF transceiver circuitry 822 may condition RF signals for processing circuitry 820.

In certain embodiments, some or all of the functionality described herein as being performed by a WD may be provided by processing circuitry 820 executing instructions stored on device readable medium 830, which in certain embodiments may be a computer-readable storage medium. In alternative embodiments, some or all of the functionality may be provided by processing circuitry 820 without executing instructions stored on a separate or discrete device readable storage medium, such as in a hard-wired manner. In any of those particular embodiments, whether executing instructions stored on a device readable storage medium or not, processing circuitry 820 can be configured to perform the described functionality. The benefits provided by such functionality are not limited to processing circuitry 820 alone or to other components of WD 810, but are enjoyed by WD 810 as a whole, and/or by end users and the wireless network generally.

Processing circuitry 820 may be configured to perform any determining, calculating, or similar operations (e.g., certain obtaining operations) described herein as being performed by a WD. These operations, as performed by processing circuitry 820, may include processing information obtained by processing circuitry 820 by, for example, converting the obtained information into other information, comparing the obtained information or converted information to information stored by WD 810, and/or performing one or more operations based on the obtained information or converted information, and as a result of said processing making a determination.

Device readable medium 830 may be operable to store a computer program, software, an application including one or more of logic, rules, code, tables, etc. and/or other instructions capable of being executed by processing circuitry 820. Device readable medium 830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 820. In some embodiments, processing circuitry 820 and device readable medium 830 may be considered to be integrated.

User interface equipment 832 may provide components that allow for a human user to interact with WD 810. Such interaction may be of many forms, such as visual, audial, tactile, etc. User interface equipment 832 may be operable to produce output to the user and to allow the user to provide input to WD 810. The type of interaction may vary depending on the type of user interface equipment 832 installed in WD 810. For example, if WD 810 is a smart phone, the interaction may be via a touch screen; if WD 810 is a smart meter, the interaction may be through a screen that provides usage (e.g., the number of gallons used) or a speaker that provides an audible alert (e.g., if smoke is detected). User interface equipment 832 may include input interfaces, devices and circuits, and output interfaces, devices and circuits. User interface equipment 832 is configured to allow input of information into WD 810, and is connected to processing circuitry 820 to allow processing circuitry 820 to process the input information. User interface equipment 832 may include, for example, a microphone, a proximity or other sensor, keys/buttons, a touch display, one or more cameras, a USB port, or other input circuitry. User interface equipment 832 is also configured to allow output of information from WD 810, and to allow processing circuitry 820 to output information from WD 810. User interface equipment 832 may include, for example, a speaker, a display, vibrating circuitry, a USB port, a headphone interface, or other output circuitry. Using one or more input and output interfaces, devices, and circuits, of user interface equipment 832, WD 810 may communicate with end users and/or the wireless network, and allow them to benefit from the functionality described herein.

Auxiliary equipment 834 is operable to provide more specific functionality which may not be generally performed by WDs. This may comprise specialized sensors for doing measurements for various purposes, interfaces for additional types of communication such as wired communications etc. The inclusion and type of components of auxiliary equipment 834 may vary depending on the embodiment and/or scenario.

Power source 836 may, in some embodiments, be in the form of a battery or battery pack. Other types of power sources, such as an external power source (e.g., an electricity outlet), photovoltaic devices or power cells, may also be used. WD 810 may further comprise power circuitry 837 for delivering power from power source 836 to the various parts of WD 810 which need power from power source 836 to carry out any functionality described or indicated herein. Power circuitry 837 may in certain embodiments comprise power management circuitry.

Power circuitry 837 may additionally or alternatively be operable to receive power from an external power source; in which case WD 810 may be connectable to the external power source (such as an electricity outlet) via input circuitry or an interface such as an electrical power cable.

Power circuitry 837 may also in certain embodiments be operable to deliver power from an external power source to power source 836. This may be, for example, for the charging of power source 836. Power circuitry 837 may perform any formatting, converting, or other modification to the power from power source 836 to make the power suitable for the respective components of WD 810 to which power is supplied.

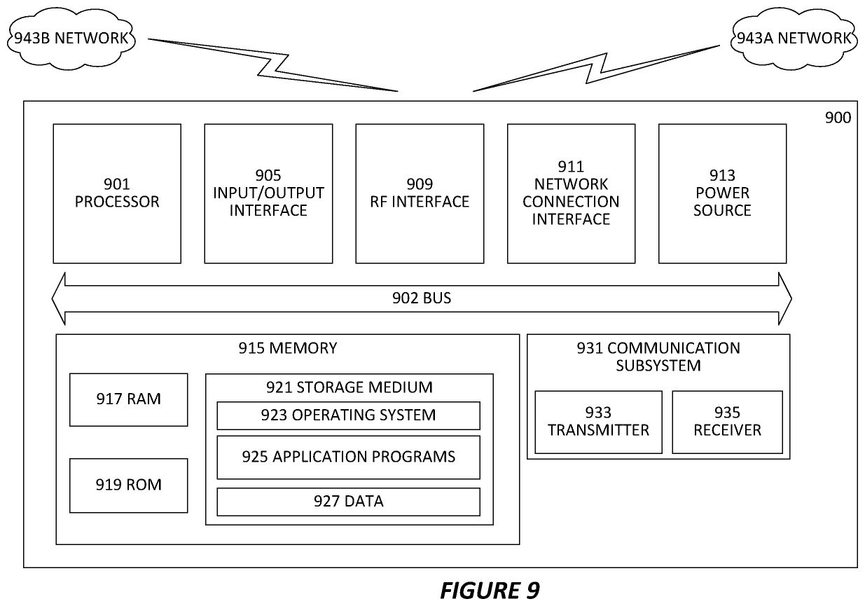

FIG. 9 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 9200 may be any UE identified by the 3^{rd} Generation Partnership Project (3GPP), including a NB-IoT UE, a machine type communication (MTC) UE, and/or an enhanced MTC (eMTC) UE. UE 900, as illustrated in FIG. 9, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 9 is a UE, the components discussed herein are equally applicable to a WD, and vice-versa.

In FIG. 9, UE 900 includes processing circuitry 901 that is operatively coupled to input/output interface 905, radio frequency (RF) interface 909, network connection interface 911, memory 915 including random access memory (RAM) 917, read-only memory (ROM) 919, and storage medium 921 or the like, communication subsystem 931, power source 933, and/or any other component, or any combination thereof. Storage medium 921 includes operating system 923, application program 925, and data 927. In other embodiments, storage medium 921 may include other similar types of information. Certain UEs may utilize all of the components shown in FIG. 9, or only a subset of the components. The level of integration between the components may vary from one UE to another UE. Further, certain UEs may contain multiple instances of a component, such as multiple processors, memories, transceivers, transmitters, receivers, etc.

In FIG. 9, processing circuitry 901 may be configured to process computer instructions and data. Processing circuitry 901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 901 may include two central processing units (CPUs). Data may be information in a form suitable for use by a computer.

In the depicted embodiment, input/output interface 905 may be configured to provide a communication interface to an input device, output device, or input and output device. UE 900 may be configured to use an output device via input/output interface 905. An output device may use the same type of interface port as an input device. For example, a USB port may be used to provide input to and output from UE 900. The output device may be a speaker, a sound card, a video card, a display, a monitor, a printer, an actuator, an emitter, a smartcard, another output device, or any combination thereof. UE 900 may be configured to use an input device via input/output interface 905 to allow a user to capture information into UE 900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 9, RF interface 909 may be configured to provide a communication interface to RF components such as a transmitter, a receiver, and an antenna. Network connection interface 911 may be configured to provide a communication interface to network 943a.

Network 943a may encompass wired and/or wireless networks such as a local-area network (LAN), a wide-area network (WAN), a computer network, a wireless network, a telecommunications network, another like network or any combination thereof. For example, network 943a may comprise a Wi-Fi network. Network connection interface 911 may be configured to include a receiver and a transmitter interface used to communicate with one or more other devices over a communication network according to one or more communication protocols, such as Ethernet, TCP/IP, SONET, ATM, or the like. Network connection interface 911 may implement receiver and transmitter functionality appropriate to the communication network links (e.g., optical, electrical, and the like). The transmitter and receiver functions may share circuit components, software or firmware, or alternatively may be implemented separately.

RAM 917 may be configured to interface via bus 902 to processing circuitry 901 to provide storage or caching of data or computer instructions during the execution of software programs such as the operating system, application programs, and device drivers. ROM 919 may be configured to provide computer instructions or data to processing circuitry 901. For example, ROM 919 may be configured to store invariant low-level system code or data for basic system functions such as basic input and output (I/O), startup, or reception of keystrokes from a keyboard that are stored in a non-volatile memory. Storage medium 921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 921 may be configured to include operating system 923, application program 925 such as a web browser application, a widget or gadget engine or another application, and data file 927. Storage medium 921 may store, for use by UE 900, any of a variety of various operating systems or combinations of operating systems.

Storage medium 921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 921 may allow UE 900 to access computer-executable instructions, application programs or the like, stored on transitory or non-transitory memory media, to off-load data, or to upload data. An article of manufacture, such as one utilizing a communication system may be tangibly embodied in storage medium 921, which may comprise a device readable medium.

In FIG. 9, processing circuitry 901 may be configured to communicate with network 943b using communication subsystem 931. Network 943a and network 943b may be the same network or networks or different network or networks. Communication subsystem 931 may be configured to include one or more transceivers used to communicate with network 943b. For example, communication subsystem 931 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 933 and/or receiver 935 to implement transmitter or receiver functionality, respectively, appropriate to the RAN links (e.g., frequency allocations and the like). Further, transmitter 933 and receiver 935 of each transceiver may share circuit components, software or firmware, or alternatively may be implemented separately.

In the illustrated embodiment, the communication functions of communication subsystem 931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 931 may include cellular communication, Wi-Fi communication, Bluetooth communication, and GPS communication. Network 943b may encompass wired and/or wireless networks such as a local-area network (LAN), a wide-area network (WAN), a computer network, a wireless network, a telecommunications network, another like network or any combination thereof. For example, network 943b may be a cellular network, a Wi-Fi network, and/or a near-field network. Power source 913 may be configured to provide alternating current (AC) or direct current (DC) power to components of UE 900.

The features, benefits and/or functions described herein may be implemented in one of the components of UE 900 or partitioned across multiple components of UE 900. Further, the features, benefits, and/or functions described herein may be implemented in any combination of hardware, software or firmware. In one example, communication subsystem 931 may be configured to include any of the components described herein. Further, processing circuitry 901 may be configured to communicate with any of such components over bus 902. In another example, any of such components may be represented by program instructions stored in memory that when executed by processing circuitry 901 perform the corresponding functions described herein. In another example, the functionality of any of such components may be partitioned between processing circuitry 901 and communication subsystem 931. In another example, the non-computationally intensive functions of any of such components may be implemented in software or firmware and the computationally intensive functions may be implemented in hardware.

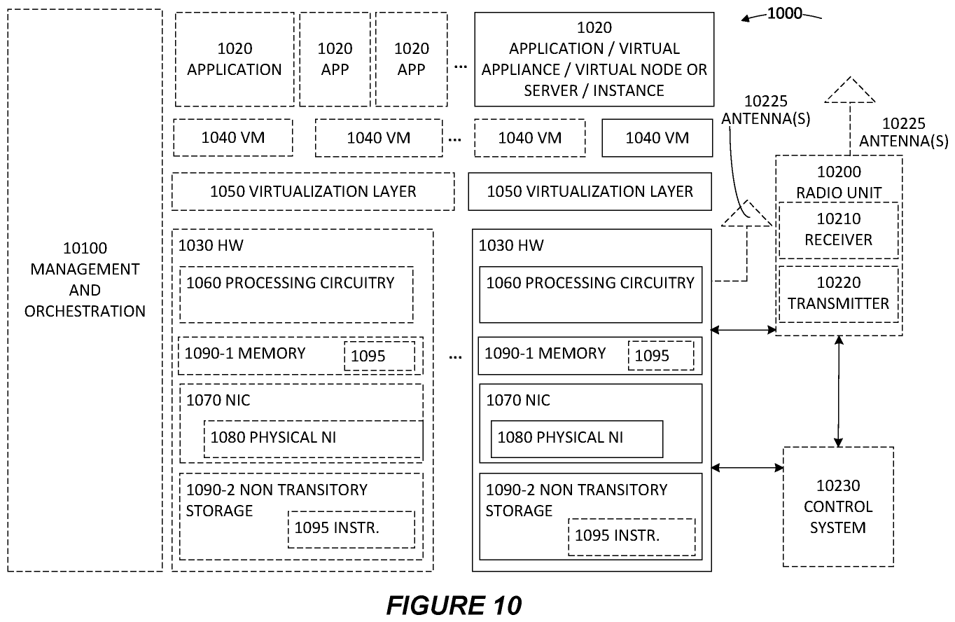

FIG. 10 is a schematic block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1000 hosted by one or more of hardware nodes 1030.

Further, in embodiments in which the virtual node is not a radio access node or does not require radio connectivity (e.g., a core network node), then the network node may be entirely virtualized.

The functions may be implemented by one or more applications 1020 (which may alternatively be called software instances, virtual appliances, network functions, virtual nodes, virtual network functions, etc.) operative to implement some of the features, functions, and/or benefits of some of the embodiments disclosed herein. Applications 1020 are run in virtualization environment 1000 which provides hardware 1030 comprising processing circuitry 1060 and memory 1090. Memory 1090 contains instructions 1095 executable by processing circuitry 1060 whereby application 1020 is operative to provide one or more of the features, benefits, and/or functions disclosed herein.

Virtualization environment 1000, comprises general-purpose or special-purpose network hardware devices 1030 comprising a set of one or more processors or processing circuitry 1060, which may be commercial off-the-shelf (COTS) processors, dedicated Application Specific Integrated Circuits (ASICs), or any other type of processing circuitry including digital or analog hardware components or special purpose processors. Each hardware device may comprise memory 1090-1 which may be non-persistent memory for temporarily storing instructions 1095 or software executed by processing circuitry 1060. Each hardware device may comprise one or more network interface controllers (NICs) 1070, also known as network interface cards, which include physical network interface 1080. Each hardware device may also include non-transitory, persistent, machine-readable storage media 1090-2 having stored therein software 1095 and/or instructions executable by processing circuitry 1060. Software 1095 may include any type of software including software for instantiating one or more virtualization layers 1050 (also referred to as hypervisors), software to execute virtual machines 1040 as well as software allowing it to execute functions, features and/or benefits described in relation with some embodiments described herein.

Virtual machines 1040, comprise virtual processing, virtual memory, virtual networking or interface and virtual storage, and may be run by a corresponding virtualization layer 1050 or hypervisor. Different embodiments of the instance of virtual appliance 1020 may be implemented on one or more of virtual machines 1040, and the implementations may be made in different ways.

During operation, processing circuitry 1060 executes software 1095 to instantiate the hypervisor or virtualization layer 1050, which may sometimes be referred to as a virtual machine monitor (VMM). Virtualization layer 1050 may present a virtual operating platform that appears like networking hardware to virtual machine 1040.

As shown in FIG. 10, hardware 1030 may be a standalone network node with generic or specific components. Hardware 1030 may comprise antenna 10225 and may implement some functions via virtualization. Alternatively, hardware 1030 may be part of a larger cluster of hardware (e.g. such as in a data center or customer premise equipment (CPE)) where many hardware nodes work together and are managed via management and orchestration (MANO) 10100, which, among others, oversees lifecycle management of applications 1020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1040 may be a software implementation of a physical machine that runs programs as if they were executing on a physical, non-virtualized machine. Each of virtual machines 1040, and that part of hardware 1030 that executes that virtual machine, be it hardware dedicated to that virtual machine and/or hardware shared by that virtual machine with others of the virtual machines 1040, forms a separate virtual network elements (VNE).

Still in the context of NFV, Virtual Network Function (VNF) is responsible for handling specific network functions that run in one or more virtual machines 1040 on top of hardware networking infrastructure 1030 and corresponds to application 1020 in FIG. 10.

In some embodiments, one or more radio units 10200 that each include one or more transmitters 10220 and one or more receivers 10210 may be coupled to one or more antennas 10225. Radio units 10200 may communicate directly with hardware nodes 1030 via one or more appropriate network interfaces and may be used in combination with the virtual components to provide a virtual node with radio capabilities, such as a radio access node or a base station.

In some embodiments, some signalling can be effected with the use of control system 10230 which may alternatively be used for communication between the hardware nodes 1030 and radio units 10200.

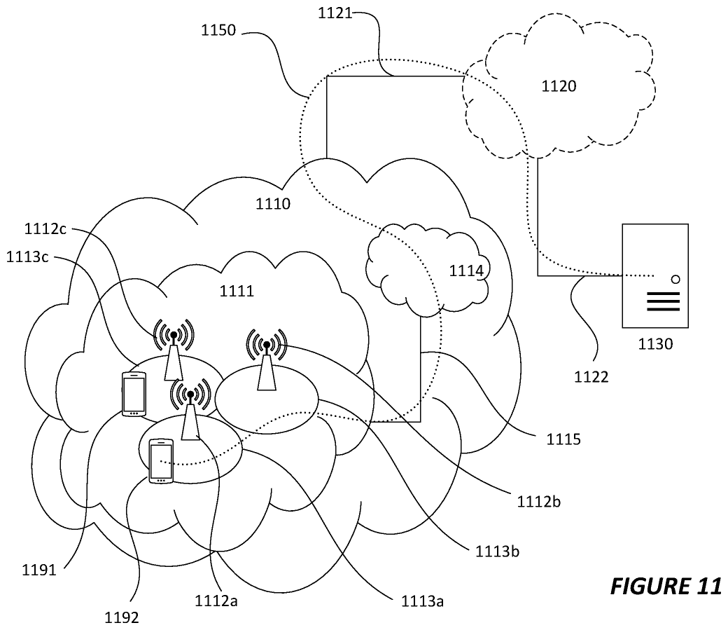

FIG. 11 illustrates a telecommunication network connected via an intermediate network to a host computer in accordance with some embodiments. In particular, with reference to FIG. 11, in accordance with an embodiment, a communication system includes telecommunication network 1110, such as a 3GPP-type cellular network, which comprises access network 1111, such as a radio access network, and core network 1114. Access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120.

Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

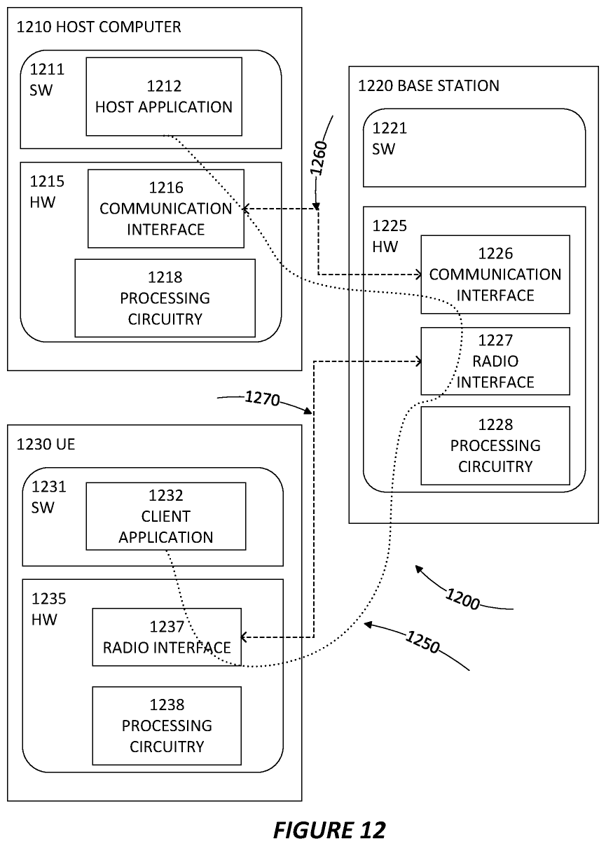

Example implementations, in accordance with an embodiment, of the UE, base station and host computer discussed in the preceding paragraphs will now be described with reference to FIG. 12. FIG. 12 illustrates host computer communicating via a base station with a user equipment over a partially wireless connection in accordance with some embodiments In communication system 1200, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212.

Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located.

Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

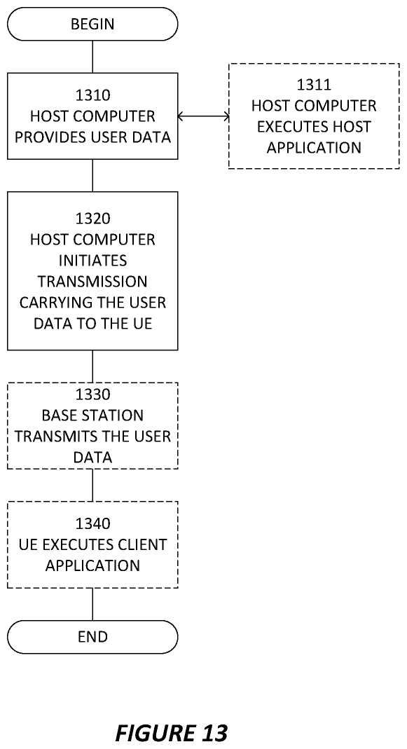

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

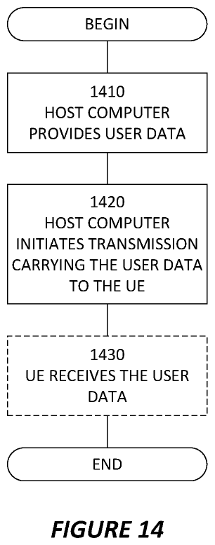

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1410 of the method, the host computer provides user data. In an optional substep (not shown) the host computer provides the user data by executing a host application.

In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

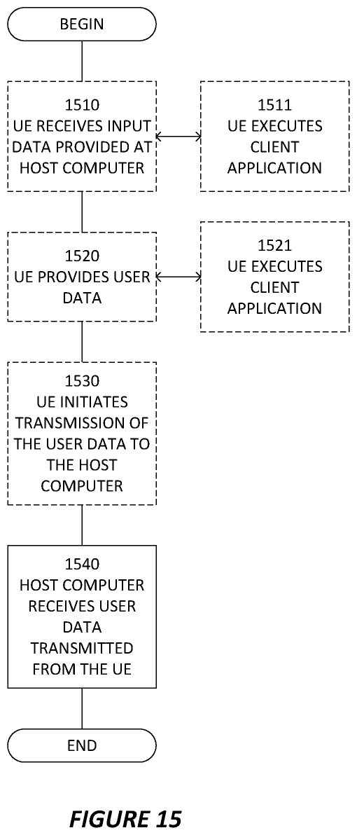

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

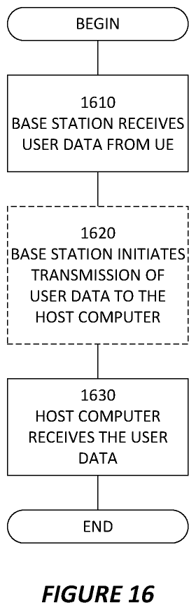

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

Any appropriate steps, methods, features, functions, or benefits disclosed herein may be performed through one or more functional units or modules of one or more virtual apparatuses.

Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE). The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer.

The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer.

The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate.

Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless device, the method comprising:
   configuring an application layer of the wireless device with an application layer configuration that governs performance of measurements at the application layer and/or reporting of those measurements to a radio network layer of the wireless device;
   after configuring the application layer with the application layer configuration, receiving at the radio network layer a message indicating a target configuration with which the wireless device is to be configured in association with a radio network layer procedure; and
   based on receiving the message, if each of one or more conditions are fulfilled, sending from the radio network layer to the application layer an instruction on how the application layer is to handle the application layer configuration.
A2. The method of embodiment A1, wherein the one or more conditions include a condition that the message indicates a full configuration option is applicable for the message, wherein according to the full configuration option the wireless device is to be configured with the target configuration independent of any previous configuration of the wireless device.
A3. The method of any of embodiments A1-A3, wherein the radio network layer procedure is a procedure for handing over a radio network layer connection of the wireless device from a source network node to a target network node or a procedure for resuming or re-establishing at a target network node a radio network layer connection previously established at a source radio network node, and wherein the target configuration is a configuration with which the wireless device is to be configured for being served by the target network node.
A4. The method of any of embodiments A1-A3, wherein the one or more conditions include a condition that a target network node of the radio network layer procedure lacks full support of the application layer configuration.
A5. The method of any of embodiments A1-A4, wherein the one or more conditions include a condition that a target network node of the radio network layer procedure and a source network node of the radio network layer procedure are different network nodes.
A6. The method of any of embodiments A1-A5, further comprising starting a timer upon reception of the message, and wherein the one or more conditions include a condition that the timer expires.
A7. The method of embodiment A6, further comprising, after successfully executing the radio network layer procedure to a first target network node, stopping the timer upon successfully executing another radio network layer procedure to a second target network node.
A8. The method of any of embodiments A1-A7, wherein the one or more conditions include a condition that the wireless device successfully connects to a target network node or cell of the radio network layer procedure.
A9. The method of any of embodiments A1-A7, wherein the one or more conditions include a condition that the wireless device disconnects from a source network node or cell of the radio network layer procedure.
A10. The method of any of embodiments A1-A9, wherein the instruction on how the application layer is to handle the application layer configuration is an instruction that the application layer is to:
   delete or suspend at least a part of the application layer configuration; and/or
   reconfigure or replace at least a part of the application layer configuration; and/or
   stop or suspend performance of one or more actions governed by the application layer configuration.
A11. The method of embodiment A10, wherein:
   the at least a part of the application layer configuration that is to be deleted, suspended, reconfigured, or replaced according to the instruction is a part that governs reporting of the measurements to the radio network layer and excludes a part that governs performance of the measurements at the application layer; and/or
   the one or more actions whose performance is to be stopped or suspended according to the instruction includes reporting of the measurements to the radio network layer and excludes performance of the measurements at the application layer.
A12. The method of any of embodiments A1-A11, wherein the instruction on how the application layer is to handle the application layer configuration is an instruction that the application layer is to delete at least some measurement data collected in accordance with the application layer configuration.
A13. The method of any of embodiments A1-A12, wherein the instruction on how the application layer is to handle the application layer configuration is an instruction that the application layer is to suspend at least a part of the application layer configuration, and wherein the method further comprises:
   starting a timer upon reception of the message;
   if the timer expires, sending from the radio network layer to the application layer a further instruction that the application layer is to delete the at least part of the application layer configuration that was suspended; and
   if, after successfully executing the radio network layer procedure to a first target network node, the wireless device successfully executes another radio network layer procedure to a second target network node before the timer expires, sending from the radio network layer to the application layer a further instruction that the application layer is to resume the at least part of the application layer configuration that was suspended.
A14. The method of any of embodiments A1-A12, wherein the instruction on how the application layer is to handle the application layer configuration is an instruction that the application layer is to suspend at least a part of the application layer configuration, that the application layer is to start a timer, and that the application layer is to delete the at least part of the application layer configuration that was suspended upon expiration of the timer, and wherein the method further comprises:
   starting a corresponding timer at the radio network layer; and
   if, after successfully executing the radio network layer procedure to a first target network node, the wireless device successfully executes another radio network layer procedure to a second target network node before the corresponding timer expires, sending from the radio network layer to the application layer a further instruction that the application layer is to resume the at least part of the application layer configuration that was suspended.
A15. The method of any of embodiments A1-A14, wherein the application layer is configured with multiple concurrent application layer configurations, and wherein the instruction indicates to which of the multiple concurrent application layer configurations the instruction applies.
A16. The method of any of embodiments A1-A15, wherein the radio network layer is a radio resource control layer.
A17. The method of any of embodiments A1-A16, wherein the application layer configuration is a quality of experience, QoE, measurement and/or reporting configuration that governs performance of QoE measurements at the application layer and/or reporting of the QoE measurements to the radio network layer.
A18. The method of any of embodiments A1-A17, further comprising receiving the instruction at the application layer, and handling the application layer configuration at the application layer in accordance with the received instruction.
AA. The method of any of the previous embodiments, further comprising:
   providing user data; and
   forwarding the user data to a host computer via the transmission to a base station.

### Group AA Embodiments

AA1. A method in a wireless device for managing a QoE measurement and reporting configuration when moving from a first cell, controlled by a first network node, to a second cell, controlled by a second network node, wherein the second cell and the second network node lacks full support for the QoE measurement and reporting configuration the wireless device has obtained from the first network node in the first cell, wherein the QoE measurement and reporting configuration is a part of a radio network layer configuration, wherein the method comprises:
   receiving a message from the second network node containing a full radio network layer configuration (fullConfig) which should replace the existing radio network layer configuration in the wireless device; and
   if at least a first condition is fulfilled, passing from a radio network layer in the wireless device to an application layer in the wireless device an instruction to stop performing at least a part of the actions associated with the QoE measurement and reporting configuration at the application layer.
AA2. The method of embodiment AA1, wherein the at least first condition comprises that the wireless device has successfully connected to the second network node in the second cell.
AA3. The method of embodiment AA1 or AA2, further comprising starting a first timer upon reception of the message from the second network node and wherein the at least first condition comprises expiration of the first timer.
AA4. The method of any of embodiments AA1-AA3, wherein the instruction passed from the radio network layer to the application layer in the wireless device comprises instructing the application layer to delete the QoE measurement and reporting configuration at the application layer and delete any measurement data collected in accordance with the QoE measurement and reporting configuration at the application layer.
AA5. The method of embodiment AA1, wherein the at least first condition comprises that the wireless device has disconnected from the first cell.
AA6. The method of any of embodiments AA1-AA5, further comprising that, prior to successfully connecting to the second cell or prior to starting the timer, the radio network layer passes an instruction to the application layer in the wireless device, instructing the application layer to suspend at least parts of the application layer QoE measurement and reporting configuration and associated actions.
AA7. The method of embodiment AA6, wherein the instructed suspension comprises suspension of all of the application layer QoE measurement and reporting configuration and any associated actions.
AA8. The method of embodiment AA6, wherein the instructed suspension comprises suspension of the QoE measurement reporting while leaving any collection of QoE measurement data in accordance with the QoE measurement configuration at the application layer unsuspended.
AA9. The method of any of embodiments AA6-AA8, further comprising that if the wireless device reconnects to the first network node in the first cell without the at least first condition having been fulfilled, the radio network layer passes an instruction to the application layer in the wireless device, instructing the application layer to resume (i.e. reactivate from suspension) the suspended all or parts of the application layer QoE measurement and reporting configuration and any suspended associated actions.
AA10. The method of any of embodiments AA6-AA8, further comprising that if the wireless device successfully re-establishes a connection in a third cell without the at least first condition having been fulfilled, the radio network layer passes an instruction to the application layer in the wireless device, instructing the application layer to resume (i.e. reactivate from suspension) the suspended all or parts of the application layer QoE measurement and reporting configuration and any suspended associated actions.
AA11. The method of any of embodiments AA1-AA5, wherein the instruction passed from the radio network layer to the application layer in the wireless device comprises instructing the application layer to start a second timer and, if the timer expires, delete the QoE measurement and reporting configuration at the application layer and delete any measurement data collected in accordance with the QoE measurement and reporting configuration at the application layer.
AA12. The method of embodiment AA11, further comprising that the instruction passed from the radio network layer to the application layer in the wireless device comprises instructing the application layer to suspend at least parts of the application layer QoE measurement and reporting configuration and associated actions in conjunction with starting of the second timer.
AA13. The method of embodiment AA12, wherein the instructed suspension comprises suspension of all of the application layer QoE measurement and reporting configuration and any associated actions.
AA14. The method of embodiment AA12, wherein the instructed suspension comprises suspension of the QoE measurement reporting while leaving any collection of QoE measurement data in accordance with the QoE measurement configuration at the application layer unsuspended.
AA15. The method of any of embodiments AA12-AA13, further comprising that if the wireless device reconnects to the first network node in the first cell without the at least first condition having been fulfilled, the radio network layer passes an instruction to the application layer in the wireless device, instructing the application layer to stop the second timer and resume (i.e. reactivate from suspension) the suspended all or parts of the application layer QoE measurement and reporting configuration and any suspended associated actions.
AA16. The method of any of embodiments AA12-AA14, further comprising that if the wireless device successfully re-establishes a connection in a third cell without the at least first condition having been fulfilled, the radio network layer passes an instruction to the application layer in the wireless device, instructing the application layer to stop the second timer and resume (i.e. reactivate from suspension) the suspended all or parts of the application layer QoE measurement and reporting configuration and any suspended associated actions.
AA17. The method of any of embodiments AA15-AA16, further comprising that the radio network layer in the wireless device, in conjunction with the passing of the instruction to the application layer in the wireless device, starts a third timer at the same value as the second timer and further comprising that the radio network layer in the wireless device passes the instruction to the application layer to resume the QoE measurement and reporting configuration and any associated actions at the application layer only if the third timer has not expired.
AA18. The method of any of embodiments AA1-AA17 involving at least one of the first timer, the second timer and the third timer, wherein the start value or expiration value of one or more of the first timer, the second timer and the third timer is/are configured in the wireless device by a network node.
AA19. The method of embodiment AA18, wherein the network node is the first network node.
AA20. The method of embodiments AA18-AA19, wherein the configuration of start or expiration value(s) is conveyed using dedicated control signaling together with the QoE measurement and reporting configuration.
AA21. The method of any of embodiments AA18-AA19, wherein the configuration of start or expiration value(s) is conveyed using common control signaling in the form of system information.
AA22. The method of any of embodiments AA1-AA17 involving at least one of the first timer, the second timer and the third timer, wherein the start value or expiration value of one or more of the first timer, the second timer and the third timer is/are hardcoded in a standard specification.
AA23. The method of any of embodiments AA1-AA22, wherein the radio network layer is a Radio Resource Control (RRC) layer.
AA24. The method of any of embodiments AA1-AA23, wherein each of the first network node and the second network node is either a gNB or an eNB.

### Group B Embodiments

B1. A method performed by a radio network node serving a wireless device, the method comprising:
   configuring an application layer of the wireless device with an application layer configuration that governs performance of measurements at the application layer and/or reporting of those measurements to a radio network layer of the wireless device; and
   after the wireless device disconnects from the radio network node, at least temporarily preserving the application layer configuration at the radio network node.
B2. The method of embodiment 1, further comprising, after the wireless device has disconnected from the radio network node, if the wireless device re-connects to the radio network node while the application layer configuration is still preserved at the radio network node, resuming use of the application layer configuration for the wireless device.
B3. The method of any of embodiments B1-B2, wherein said at least temporarily preserving comprises:
   starting a timer upon the wireless device disconnecting from the radio network node; and
   preserving the application layer configuration until the timer expires.
B4. The method of embodiment B3, further comprising stopping the timer upon the wireless device re-connecting to the radio network node.
B5. The method of any of embodiments B1-B4, wherein the radio network layer is a radio resource control layer.
B6. The method of any of embodiments B1-B5, wherein the application layer configuration is a quality of experience, QoE, measurement and/or reporting configuration that governs performance of QoE measurements at the application layer and/or reporting of the QoE measurements to the radio network layer.
BB. The method of any of the previous embodiments, further comprising:
   obtaining user data; and
   forwarding the user data to a host computer or a wireless device.

### Group C Embodiments

C1. A wireless device configured to perform any of the steps of any of the Group A or Group AA embodiments.
C2. A wireless device comprising processing circuitry configured to perform any of the steps of any of the Group A or Group AA embodiments.
C3. A wireless device comprising:
   communication circuitry; and
   processing circuitry configured to perform any of the steps of any of the Group A or Group AA embodiments.
C4. A wireless device comprising:
   processing circuitry configured to perform any of the steps of any of the Group A or Group AA embodiments; and
   power supply circuitry configured to supply power to the wireless device.
C5. A wireless device comprising:
   processing circuitry and memory, the memory containing instructions executable by the processing circuitry whereby the wireless device is configured to perform any of the steps of any of the Group A or Group AA embodiments.
C6. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A or Group AA embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
C7. A computer program comprising instructions which, when executed by at least one processor of a wireless device, causes the wireless device to carry out the steps of any of the Group A or Group AA embodiments.
C8. A carrier containing the computer program of embodiment C7, wherein the carrier is one of an electronic signal, optical signal, radio signal, or computer readable storage medium.
C9. A radio network node configured to perform any of the steps of any of the Group B embodiments.
C10. A radio network node comprising processing circuitry configured to perform any of the steps of any of the Group B embodiments.
C11. A radio network node comprising:
   communication circuitry; and
   processing circuitry configured to perform any of the steps of any of the Group B embodiments.
C12. A radio network node comprising:
   processing circuitry configured to perform any of the steps of any of the Group B embodiments;
   power supply circuitry configured to supply power to the radio network node.
C13. A radio network node comprising:
   processing circuitry and memory, the memory containing instructions executable by the processing circuitry whereby the radio network node is configured to perform any of the steps of any of the Group B embodiments.
C14. The radio network node of any of embodiments C9-C13, wherein the radio network node is a base station.
C15. A computer program comprising instructions which, when executed by at least one processor of a radio network node, causes the radio network node to carry out the steps of any of the Group B embodiments.
C16. The computer program of embodiment C15, wherein the radio network node is a base station.
C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
D2. The communication system of the previous embodiment further including the base station.
D3. The communication system of the previous 2 embodiments, further including the UE, wherein the UE is configured to communicate with the base station.
D4. The communication system of the previous 3 embodiments, wherein:
   the processing circuitry of the host computer is configured to execute a host application, thereby providing the user data; and
   the UE comprises processing circuitry configured to execute a client application associated with the host application.
D5. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
D6. The method of the previous embodiment, further comprising, at the base station, transmitting the user data.
D7. The method of the previous 2 embodiments, wherein the user data is provided at the host computer by executing a host application, the method further comprising, at the UE, executing a client application associated with the host application.
D8. A user equipment (UE) configured to communicate with a base station, the UE comprising a radio interface and processing circuitry configured to perform any of the previous 3 embodiments.
D9. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A or Group AA embodiments.
D10. The communication system of the previous embodiment, wherein the cellular network further includes a base station configured to communicate with the UE.
D11. The communication system of the previous 2 embodiments, wherein:
   the processing circuitry of the host computer is configured to execute a host application, thereby providing the user data; and
   the UE's processing circuitry is configured to execute a client application associated with the host application.
D12. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A or Group AA embodiments.
D13. The method of the previous embodiment, further comprising at the UE, receiving the user data from the base station.
D14. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A or Group AA embodiments.
D15. The communication system of the previous embodiment, further including the UE.
D16. The communication system of the previous 2 embodiments, further including the base station, wherein the base station comprises a radio interface configured to communicate with the UE and a communication interface configured to forward to the host computer the user data carried by a transmission from the UE to the base station.
D17. The communication system of the previous 3 embodiments, wherein:
   the processing circuitry of the host computer is configured to execute a host application; and
   the UE's processing circuitry is configured to execute a client application associated with the host application, thereby providing the user data.
D18. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
D19. A method implemented in a communication system including a host computer, a base station and a user equipment (UE), the method comprising:
   at the host computer, receiving user data transmitted to the base station from the UE, wherein the UE performs any of the steps of any of the Group A or Group AA embodiments.
D20. The method of the previous embodiment, further comprising, at the UE, providing the user data to the base station.
D21. The method of the previous 2 embodiments, further comprising:
   at the UE, executing a client application, thereby providing the user data to be transmitted; and
   at the host computer, executing a host application associated with the client application.
D22. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
D24. The communication system of the previous embodiment further including the base station.
D25. The communication system of the previous 2 embodiments, further including the UE, wherein the UE is configured to communicate with the base station.
D26. The communication system of the previous 3 embodiments, wherein:
   the processing circuitry of the host computer is configured to execute a host application;
   the UE is configured to execute a client application associated with the host application, thereby providing the user data to be received by the host computer.
D27. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A or Group AA embodiments.
D28. The method of the previous embodiment, further comprising at the base station, receiving the user data from the UE.
D29. The method of the previous 2 embodiments, further comprising at the base station, initiating a transmission of the received user data to the host computer.

1-21. (canceled)

22. A method performed by a wireless device, the method comprising:
configuring an application layer of the wireless device with an application layer configuration that governs performance of measurements at the application layer and/or reporting of those measurements to a radio network layer of the wireless device;
after configuring the application layer with the application layer configuration, receiving at the radio network layer a message indicating a target configuration with which the wireless device is to be configured in association with a radio network layer procedure; and
based on receiving the message, if each of one or more conditions are fulfilled, sending from the radio network layer to the application layer an instruction on how the application layer is to handle the application layer configuration.

23. The method of claim 22, wherein the radio network layer procedure is a procedure for handing over a radio network layer connection of the wireless device from a source network node to a target network node or a procedure for resuming or re-establishing at a target network node a radio network layer connection previously established at a source radio network node, and wherein the target configuration is a configuration with which the wireless device is to be configured for being served by the target network node.

24. The method of claim 22, wherein the one or more conditions include one or more of:
a condition that the message indicates a full configuration option is applicable for the message, wherein according to the full configuration option the wireless device is to be configured with the target configuration independent of any previous configuration of the wireless device; or
a condition that a target network node of the radio network layer procedure lacks full support of the application layer configuration.

25. The method claim 22, wherein the one or more conditions include one or more of:
a condition that a target network node of the radio network layer procedure and a source network node of the radio network layer procedure are different network nodes; or
a condition that the wireless device successfully connects to a target network node or cell of the radio network layer procedure; or
a condition that the wireless device disconnects from a source network node or cell of the radio network layer procedure.

26. The method of claim 22, wherein the instruction on how the application layer is to handle the application layer configuration is an instruction that the application layer is to:
delete or suspend at least a part of the application layer configuration; and/or
reconfigure or replace at least a part of the application layer configuration; and/or
stop or suspend performance of one or more actions governed by the application layer configuration.

27. The method of claim 26, wherein:
the at least a part of the application layer configuration that is to be deleted, suspended, reconfigured, or replaced according to the instruction is a part that governs reporting of the measurements to the radio network layer and excludes a part that governs performance of the measurements at the application layer; and/or
the one or more actions whose performance is to be stopped or suspended according to the instruction includes reporting of the measurements to the radio network layer and excludes performance of the measurements at the application layer.

28. The method of claim 22, wherein the instruction on how the application layer is to handle the application layer configuration is an instruction that the application layer is to delete at least some measurement data collected in accordance with the application layer configuration.

29. The method of claim 22, wherein the application layer is configured with multiple concurrent application layer configurations, and wherein the instruction indicates to which of the multiple concurrent application layer configurations the instruction applies.

30. The method of claim 22, wherein:
the radio network layer is a radio resource control layer; and/or
the application layer configuration is a quality of experience (QoE) measurement and/or reporting configuration that governs performance of QoE measurements at the application layer and/or reporting of the QoE measurements to the radio network layer.

31. The method of claim 22, further comprising receiving the instruction at the application layer, and handling the application layer configuration at the application layer in accordance with the received instruction.

32. A wireless device comprising:
communication circuitry; and
processing circuitry configured to:
configure an application layer of the wireless device with an application layer configuration that governs performance of measurements at the application layer and/or reporting of those measurements to a radio network layer of the wireless device;
after configuring the application layer with the application layer configuration, receive at the radio network layer a message indicating a target configuration with which the wireless device is to be configured in association with a radio network layer procedure; and
based on receiving the message, if each of one or more conditions are fulfilled, send from the radio network layer to the application layer an instruction on how the application layer is to handle the application layer configuration.

33. The wireless device of claim 32, wherein the radio network layer procedure is a procedure for handing over a radio network layer connection of the wireless device from a source network node to a target network node or a procedure for resuming or re-establishing at a target network node a radio network layer connection previously established at a source radio network node, and wherein the target configuration is a configuration with which the wireless device is to be configured for being served by the target network node.

34. The wireless device of claim 32, wherein the one or more conditions include one or more of:
a condition that the message indicates a full configuration option is applicable for the message, wherein according to the full configuration option the wireless device is to be configured with the target configuration independent of any previous configuration of the wireless device; or
a condition that a target network node of the radio network layer procedure lacks full support of the application layer configuration.

35. The wireless device of claim 32, wherein the one or more conditions include one or more of:
a condition that a target network node of the radio network layer procedure and a source network node of the radio network layer procedure are different network nodes; or
a condition that the wireless device successfully connects to a target network node or cell of the radio network layer procedure; or
a condition that the wireless device disconnects from a source network node or cell of the radio network layer procedure.

36. The wireless device of claim 32, wherein the instruction on how the application layer is to handle the application layer configuration is an instruction that the application layer is to:
delete or suspend at least a part of the application layer configuration; and/or
reconfigure or replace at least a part of the application layer configuration; and/or
stop or suspend performance of one or more actions governed by the application layer configuration.

37. The wireless device of claim 36, wherein:
the at least a part of the application layer configuration that is to be deleted, suspended, reconfigured, or replaced according to the instruction is a part that governs reporting of the measurements to the radio network layer and excludes a part that governs performance of the measurements at the application layer; and/or
the one or more actions whose performance is to be stopped or suspended according to the instruction includes reporting of the measurements to the radio network layer and excludes performance of the measurements at the application layer.

38. The wireless device of claim 32, wherein the instruction on how the application layer is to handle the application layer configuration is an instruction that the application layer is to delete at least some measurement data collected in accordance with the application layer configuration.

39. The wireless device of claim 32, wherein the application layer is configured with multiple concurrent application layer configurations, and wherein the instruction indicates to which of the multiple concurrent application layer configurations the instruction applies.

40. The wireless device of claim 32, wherein:
the radio network layer is a radio resource control layer; and/or
the application layer configuration is a quality of experience (QoE) measurement and/or reporting configuration that governs performance of QoE measurements at the application layer and/or reporting of the QoE measurements to the radio network layer.

41. The wireless device of claim 32, wherein the processing circuitry is further configured to receive the instruction at the application layer, and handle the application layer configuration at the application layer in accordance with the received instruction.

42. A method performed by a radio network node serving a wireless device, the method comprising:
configuring an application layer of the wireless device with an application layer configuration that governs performance of measurements at the application layer and/or reporting of those measurements to a radio network layer of the wireless device; and
after the wireless device disconnects from the radio network node, at least temporarily preserving the application layer configuration at the radio network node.

43. The method of claim 42, further comprising, after the wireless device has disconnected from the radio network node, if the wireless device re-connects to the radio network node while the application layer configuration is still preserved at the radio network node, resuming use of the application layer configuration for the wireless device.

44. The method of claim 42, wherein said at least temporarily preserving comprises:
starting a timer upon the wireless device disconnecting from the radio network node; and
preserving the application layer configuration until the timer expires.

45. A radio network node configured to serve a wireless device, the radio network node comprising:
communication circuitry; and
processing circuitry configured to:
configure an application layer of the wireless device with an application layer configuration that governs performance of measurements at the application layer and/or reporting of those measurements to a radio network layer of the wireless device; and
after the wireless device disconnects from the radio network node, at least temporarily preserve the application layer configuration at the radio network node.

46. The radio network node of claim 45, wherein the processing circuitry is further configured to, after the wireless device has disconnected from the radio network node, if the wireless device re-connects to the radio network node while the application layer configuration is still preserved at the radio network node, resume use of the application layer configuration for the wireless device.

47. The radio network node of claim 45, wherein the processing circuitry is configured to at least temporarily preserve the application layer configuration at the radio network node by:
starting a timer upon the wireless device disconnecting from the radio network node; and
preserving the application layer configuration until the timer expires.
